(19) United States
(12) Patent Application Publication
(10) Pub. No.: US 2007/0277162 A1
(43) Pub. Date: Nov. 29, 2007

(54) Compiler apparatus, compiler method, and compiler program

(76) Inventors: Akira Tanaka, Osaka (JP); Fumihiro Hatano, Kyoto (JP); Tomohiro Yamana, Kyoto (JP); Masaaki Mineo, Osaka (JP)

Correspondence Address: MCDERMOTT WILL & EMERY LLP, 600 13TH STREET, NW, WASHINGTON, DC, 20005-3096, US

(21) Appl. No.: 11/802,636

(22) Filed: May 24, 2007

(30) Foreign Application Priority Data
May 26, 2006 (JP) 2006-146713
May 17, 2007 (JP) 2007-131506

(51) Int. Cl. G06F 9/45

(52) U.S. Cl. 717/140

(57) ABSTRACT

A high-sped block is formed by generating and connecting a new basic block (contains an intermediate code obtained by performing variable replacing processing to a path replacement target variable of the intermediate code on a hot path of an original partial program and contains a branching intermediate code where a branching instruction on the hot path is converted so as to execute the hot path), and a basic block with an intermediate code for restoring value of path guarantee variable among the path replacement target variables to a value of an original variable. When an execution result of a conditional branching intermediate code is true, the speeding up of the original program is achieved through executing the basic block, and performing dependency analysis and dependency generation between the intermediate codes in the high-speed block and scheduling of the instructions.

### BACKGROUND OF THE INVENTION

1. Field of the Invention

The present invention relates to a compiler apparatus, a compiler method, and a compiler program. More specifically, the present invention relates to a technique for achieving optimized compiling in terms of the execution speed.

2. Description of the Related Art

Conventionally, a compiler apparatus, that performs optimization to reduce the execution time of a program, is used in order to improve the performance of the program that is loaded on a computer system for processing a vast amount of data.

In the compiler apparatus, instruction scheduling for rearranging the order of instructions is used so as to improve the execution efficiency of the program in order to perform optimization. Further, in performing optimization, the compiler apparatus divides the program by a basic block unit through control flow analysis focusing attention on the instruction sentence at a branching point of the program and the instruction sentence at a branching destination. The basic block is a string of the instruction sentences wherein the instructions are executed in order from the head instruction sentence of the basic block to the last instruction sentence, and it does not contain branch and confluence in the way of the string of the instruction sentences. However, a branch instruction may be included at the end of the basic block.

There is no branch and confluence in the way of the basic block, so that scheduling of instructions by each block can be performed easily. However, the effect of optimization is limited for local optimization of each basic block. Thus, it is necessary to expand the target range of the instruction scheduling by extending the basic block.

As depicted in pp. 358-382 of “Structure and Optimization of Compiler” by Ikuo Nakata, published by Asakura Publishing Co., Ltd. in 2004, there area cases where the execution path with high execution frequency (referred to as “hot path” hereinafter) is known in advance in a program that contains a plurality of branches. In such a case, such method is conventionally known that moves the instruction sentence on the hot path to extend the basic block of the hot path so as to improve the execution efficiency of the hot path.

Now, the method for extending the basic block on the hot path will be described referring to the case of the program shown in FIG. 5A and FIG. 5B. FIG. 5A shows a part of the program, and FIG. 5B shows an intermediate program expression of the program inside the compiler. The intermediate program is constituted with a string of intermediate codes such as S1 and S2. Further, FIG. 5B also illustrates a control flow graph that shows the flow of control with solid arrows. The instruction sentence in the program is expressed as an intermediate code within the compiler. The control flow graph is a directed graph where basic blocks B1-B7 are connected through directed sides that indicate branch and confluence. Further, this example will be described on an assumption that the execution path transiting the basic blocks B1, B2, B3, B4, B5, and B7 on a broken-line arrow HP in order is a hot path.

Now, it will be described referring to a program shown in FIG. 6. In this program, as shown in FIG. 7, an intermediate code S81 that is a copy of an intermediate code S8 is inserted to the basic block B3, considering the case where the intermediate code S8 of the basic block B4 is moved to the basic block B2 and a transition from the basic block B3 to the basic block B4 is carried out. Based on this operation, it is possible to extend the basic block B2 on the hot path HP, while keeping the consistency of the program.

However, as shown in FIG. 8, in the case where there is a transition of the basic blocks B1, B2, B4 in this order and branching instruction S9 of the basic block B4 is judged as false, when an intermediate code S10 of the basic block B5 is moved to the basic block B2, a variable a of an intermediate code S12 of the basic block B6 actually has to refer to a variable a of the intermediate code S1 of the basic block B1, but it becomes to refer to a variable a of the shifted intermediate code S10. Thus, it is not possible to keep the consistency of the program.

As just described, when dependence of the original program to the data is not kept by moving the intermediate code over the basic blocks containing a branch instruction in the end, shifting of the intermediate code is restricted. Therefore, the basic block cannot be extended.

### SUMMARY OF THE INVENTION

Therefore, the main object of the present invention is to provide a compiler apparatus which can convert a program to be able to extend the basic block on a certain execution path, while keeping the consistency of the program.

(1) A compiler apparatus according to the present invention is a compiler apparatus for converting a source program that includes a branching instruction into an object program that is a string of object codes. The apparatus comprises
an execution path designating device, a first execution path code generator, a guarantee code generator, a partial code generator, a first branch code generator, a first dependency analyzer, and a parallelizing device, wherein:
the execution path designating device designates a single execution path from a plurality of execution paths contained in a partial instruction string including a branching instruction in the way thereof, that constitutes the source program;
the first execution path code generator generates a first execution path code obtained by replacing a variable, that is defined on an execution path designated by the execution path designating device and is necessary to be present at an entrance of the designated execution path, with another variable;
the guarantee code generator generates a guarantee code for restoring the another variable, that is replaced by the first execution path code generator and is necessary to be present also at an exit of the designated execution path, to an original variable;
the partial code generator generates a partial code that corresponds to the partial instruction string;
the first branch code generator generates a first branch code that branches to a start point of the partial code in the conditional branching instruction on the designated execution path, based on a condition of a conditional branching instruction on the designated execution path, when a branching condition for executing the designated execution path does not be approved;
the first dependency analyzer calculates a dependency relation between instructions based on an analysis of a dependency relation between instructions on the designated execution path, adds a dependency between the guarantee code and the branch code that corresponds to the conditional branching instruction on the designated execution path so that the guarantee code is executed later than the conditional branching instruction of the designated execution path, and adds a dependency between instructions lest any exception is generated; and
the parallelizing device rearranges instructions on the designated execution path based on the dependencies between the instructions added by the first dependency analyzer.

The structure of the present invention described above is an embodiment for setting the dependency lest any exception is generated. In this structure, the execution path designating device designates so-called a hot path in a partial instruction string that contains a branching instruction in the way thereof. The first execution path code generator generates an execution path code where the path replacement target variable (a variable required to be present at the entrance of the designated execution path and defined on the designated execution path) is replaced with another variable.

Further, the guarantee code generator generates in advance a guarantee code that is required for returning the replaced variable to the original variable. The partial code generator generates a partial code that corresponds to the partial instruction string that contains a branching instruction in the middle thereof. The first branch code generator generates a branching code where the branching destination branches to the start point of the partial code in order to adjusts at first to be the condition of the case where the designated execution path is not executed with respect to the conditional branching instruction for executing the designated execution path, and then obtain a structure that contains no branching in the middle of the execution path. This is performed to achieve high-speed processing by executing the processing in a high-speed block (execution path) when the branching condition is approved, while branching to the processing with normal sequence that does not use the high-speed block, in order to maintain the consistency when the branching condition is not approved. The first dependency analyzer finds out the dependency relation between the instructions on the designated execution path, and adjusts it in such a manner that the guarantee code comes later than the conditional branching instruction lest any exception is generated. The parallelizing device rearranges the instructions on the execution path in accordance with the obtained dependency relation between the instructions.

According to this structure, it is possible to extend the basic block on the designate execution path and expand the target range of scheduling performed on the instructions. Thus, optimization can be achieved more effectively. Further, this structure is constituted such that the instruction sentence on the execution path is executed preferentially and no branching is contained in the middle of the execution path. Therefore, it is possible to improve the execution speed of the execution path, when the execution probability of the execution path is higher than that of other execution paths.

(2) There is such an embodiment in the compiler apparatus of (1) described above that the compiler apparatus treats a loop in the source program as a single instruction, and the apparatus further comprises a loop unit processing device, wherein
the loop unit processing device starts up the execution path designating device, the first execution path code generator, the guarantee code generator, the first branch code generator, the first dependency analyzer, and the parallelizing device from an innermost loop of the loop towards an outer loop.

Through providing the loop unit processing device, the designated range of the execution path can be repeatedly expanded from the innermost loop towards the outer loop. Therefore, the execution speed of the program can be improved in a much wider range.

(3) There is such an embodiment in the compiler apparatus of (1) described above that the compiler apparatus further comprises a first execution path conversion judging device, wherein the first execution path conversion judging device judges whether or not the program after executing the parallelizing device is taken as the object codes, based on an execution probability of the designated execution path.

If the program after the parallelizing device is executed is taken as the object codes at all times irrespective of under the condition that the execution probability of the designated execution path is low, it is anticipated that the processing time is rather extended. So, the above-described execution path conversion judging device is provided. The execution path conversion judging device shortens the processing time by taking the program after executing the parallelizing device as the object codes. Inversely, when the execution probability of the designated execution path is equal to or less than a prescribed value, the execution path conversion judging device takes the original program as the object codes without executing the parallelizing device. Herewith, the processing time can be shortened further.

(4) There is also such an embodiment in the compiler apparatus of (1) described above that the compiler apparatus further comprises a second execution path conversion judging device, wherein the second execution path conversion judging device:
calculates average execution time of the partial code, based on an execution probability of the designated execution path and execution time of the partial code;
calculates average execution time of the designated execution path, based on execution time of the object codes on the designated execution path after execution of the parallelizing device, and the execution probability; and
judges whether or not the program after execution of the parallelizing device is taken as a string of the object codes, based on a comparison between the average execution time of the partial code and the average execution time of the designated execution path.

In judging whether to take the program after execution of the parallelizing device as the object codes or to take the original program as the object codes without executing the parallelizing device, it may be insufficient in terms of the accuracy of shortening the processing time to employ only the judgment with respect to the execution probability of the designated execution path. It is a reason because the processing time and the probability have different dimensions each other. Thus, the second execution path conversion judging device is provided for performing a comparison judgment in terms of time. This execution path conversion judging device calculates the average execution time on the designated execution path and the average execution time in the partial code respectively. Then, the execution path conversion judging device sets the program after execution of the parallelizing device as the object codes, when the average execution time on the execution path after execution of the parallelizing device is shorter than the average execution time of the partial code. As a result, the processing time can be more securely shortened.

(5) There is also such an embodiment that the compiler apparatus of (1) described above further comprises a return position setting instruction code generator and a second dependency analyzer, wherein:
the return point setting instruction code generator adds an instruction code for specifying a return position on the designated execution path when an exception is generated during execution of the designated execution path; and
the second dependency analyzer, based on an analysis of a dependency relation between instructions on the designated execution path, adds a dependency between the guarantee code and the branch code that corresponds to the conditional branching instruction on the designated execution path so that the guarantee code is executed later than the conditional branching instruction on the designated execution path; and
the second dependency analyzer does not add the dependency, that is added between the instructions by the first dependency analyzer so as to not generate an exception.

This is a structure where dependency is not set in order to not generate an exception through setting the return position at the time of exception. Modification Example 1 of the embodiment described later can be referred for this structure.

If zero-division is generated, an exception is generated in the processor or the operating system. Further, when the variable f is the pointer variable in C-language and there is an indirect reference of the variable f, an exception is generated in the processor or the operating system in cases where the variable holds the unloaded address or the address of the memory to which an access is inhibited. As a measure for this, the aforementioned return point setting instruction code generator and the dependency analyzer are provided. That is, the return point for the case of an exception is set so that the execution of the program can be continued without a contradiction even in the case where an exception is generated in the instruction that is executed speculatively. As a result, even the instruction on the designated execution path, that is possible to generate an exception, can be moved on the designated execution path without restrictions. Therefore, parallel execution of the instructions can be more facilitated so as to improve the execution speed.

(6) There is also such an embodiment in the compiler apparatus of (5) described above that the compiler apparatus further comprises an processing routine adder at a time of generation of interruption, wherein the processing routine adder at a time of generation of interruption adds a processing routine for returning to the return position designated by the instruction code, to the object codes, when an exception is generated. This structure continues an execution of the program by carrying out the processing at generation of an exception with the interruption routine (on software). Modification Example 1 of the embodiment described later can be referred for this structure. By taking the structure described above, it is possible to avoid the obstacles, that may be generated due to the dependency, to high-speed execution on the designated execution path, and to move the instruction on the designated execution path, that is possible to generate an exception, on the designated execution path without restrictions. Herewith, parallel execution of the instructions can be facilitated further so as to improve the execution speed.

(7) There is also such an embodiment in the compiler apparatus of (6) described above that the compiler apparatus further comprises a third execution path conversion judging device, wherein the third execution path conversion judging device judges whether or not the program after executing the parallelizing device is taken as the object codes, based on an execution probability of the designated execution path and a probability of generating an exception on the execution path after execution of the parallelizing device.

If it is constituted like this, the probability of generating the exception on the designated execution path is added as a basis for judgments. Thus, it is possible to shorten the processing time more in detail in accordance with changes of the circumstances, compared to the case where the probability of generating the exception is not taken into consideration.

(8) There is also such an embodiment in the compiler apparatus of (7) described above that the compiler apparatus further comprises a fourth execution path conversion judging device, wherein the fourth execution path conversion judging device:
calculates average execution time of the partial code, based on the execution probability of the designated execution path, the probability of generating an exception on the designated execution path, and execution time of the partial code;
calculates average execution time of the designated execution path after executing the parallelizing device and average execution time of the processing routine, based on the execution probability of the designated execution path, the probability of generating the exception, execution time of the object codes on the execution path after executing the parallelizing device, and execution time of the object codes in the processing routine added by the processing routine adding device at a time of generation of interruption; and
judges whether or not the program after executing the parallelizing device is taken as the object codes, based on a comparison between the average execution time of the execution path after executing the parallelizing device and the average execution time of the processing routine.

If it is constituted like this, judgments are carried out not only on the basis of the average execution time of the partial code or on the basis of the average execution time of the execution path and the processing routine, but also on the basis of the comparison on the average execution time of the both. It is then determined to select any choice in this manner, so that the processing time can be shortened more securely.

(9) There is also such an embodiment in the compiler apparatus of (8) described above that the compiler apparatus further comprises a second execution path code generator, wherein:
when a variable referred to on the designated execution path often holds a specific value, the second execution path code generator replaces the variable with a value held by the variable, and when the variable holds a value different from the replaced value, it generates a second execution path code that is obtained by inserting a conditional branching instruction where a condition is set to branch towards outside of the designated execution path, at a head of the designated execution path; and
the compiler apparatus performs optimization for eliminating redundancy with respect to a constant value, after the second execution path code generator is started up.

If it is constituted like this, it is possible to shorten the processing time more securely when the value held by the variable is deviated to a specific value.

(10) There is also such an embodiment in the compiler apparatus of (9) described above that the compiler apparatus further comprises a fifth execution path conversion judging device, wherein the fifth execution path conversion judging device judges whether or not the second execution path code generator is executed, based on the execution probability of the designated execution path and the probability where the variable on the designated execution path holds a specific value.

If it is constituted like this, the probability where the variable on the designated execution path holds a specific value is taken into consideration. Thus, it is possible to shorten the processing time more in detail in accordance with changes of the circumstances, compared to the case where the probability is not taken into consideration.

(11) There is also such an embodiment in the compiler apparatus of (10) described above that the compiler apparatus further comprises a sixth execution path conversion judging device, wherein the sixth execution path conversion judging device:
calculates average execution time of the execution path after executing the parallelizing device, based on the execution probability of the designated execution path, the probability where the variable on the designated execution path holds a specific value, and execution time of the object codes on the execution path after executing the parallelizing device; and
judges whether or not the program after executing the parallelizing device is taken as the object codes based on a comparison between the average execution time of the execution path after executing the parallelizing device and the average execution time of the partial code.

If it is constituted like this, judgments are carried out not only on the basis of the average execution time of the partial code or on the basis of the average execution time of the execution path associated with the probability of the variable on the execution path having a specific value, but also on the basis of the comparison on the average execution time of the both. It is then determined to select any choice, so that the processing time can be shortened more securely.

(12) There is also such an embodiment in the compiler apparatus of (11) described above that the compiler apparatus further comprises a third execution path code generator and a second branch code generator, wherein:
the third execution path code generator, when a variable referred to on the designated execution path often holds a specific value, copies instructions on the designated execution path and then replaces the variable that often takes a specific value on the copied execution path with a value held by the variable and, when a variable referred to on the designated execution path holds a value different from the replaced value, generates a third execution path code that is obtained by inserting a conditional branching instruction where a condition is set to branch towards outside of the designated execution path, at a head of the designated execution path; and
the second branch code generator generates a second branch code that branches to a start point of the designated execution path code in the conditional branching instruction on the copied execution path, when a condition of a conditional branching instruction on the copied execution path is not approved to a conditional branching instruction in the designated execution path.

If it is constituted like this, even when the variable referred to on the designated execution path holds a value different from the replaced specific value, the execution control is transited to another high-speed block whose speed is increased compared to the partial code. Thus, it is possible to shorten the processing time more securely.

(13) There is also such an embodiment in the compiler apparatus of (12) described above that the compiler apparatus further comprises a seventh execution path conversion judging device, wherein the seventh execution path conversion judging device:
calculates average execution time of the program after modification, based on the probability where the variable referred to on the designated execution path holds a specific value, or based on the execution time of the designated execution path and the probability where the variable referred to on the designated execution path holds a specific value; and
judges whether or not the third execution path code generator and the second branch code generator are executed, based on the calculated average execution time of the modified program.

If it is constituted like this, it is determined to select any choice by carrying out the judgments on the basis of the average execution time of the modified program, that is calculated from the probability of holding the specific value, or from the probability and the execution probability of the designated execution path. Therefore, the processing time can be shortened more securely.

(14) Further, a compiler apparatus according to the present invention is a compiler apparatus for converting a source program that includes a branching instruction into an object program that is a string of object codes, and the apparatus comprises
an execution path designating device, an execution path code generator, a guarantee code generator, a partial code generator, a branch code generator, a dependency analyzer, and a parallelizing device, wherein:
the execution path designating device designates a single execution path from a plurality of execution paths contained in a partial instruction string including a branching instruction in a middle thereof, that constitutes the source program;
the execution code generator generates an execution path code obtained by replacing a variable, that is defined on an execution path designated by the execution path designating device and is necessary to be present at an entrance of the designated execution path, with another variable;
the guarantee code generator generates a guarantee code for restoring the another variable, that is replaced by the execution path code generator and is necessary to be present also at an exit of the designated execution path, to an original variable;
the partial code generator generates a partial code that corresponds to the partial instruction string;
the branch code generator generates a branch code based on a condition of a conditional branching instruction on the designated execution path so that a branching destination of the conditional branching instruction on the designated execution path becomes a branching destination in a case where the branching condition in the partial code is not approved, when the branching condition for executing the designated execution path is not approved;
the dependency analyzer calculates a dependent relation between instructions based on an analysis of a dependency relation between instructions on the designated execution path, adds a dependency between an instruction present in a basic block and the conditional branching instruction so that processing cannot be shifted by going over the conditional branching instruction that is found at first towards an end direction of the execution path from an instruction in the designated execution path that is also present in the basic block where controls interflow, and adds a dependency between the instruction and the conditional branching instruction so that processing cannot be shifted by going over the conditional branching instruction from the instruction in the designated execution path that is not present in the basic block; and
the parallelizing device rearranges instructions on the designated execution path based on the dependencies between the instructions added by the dependency analyzer.

If it is constituted like this, when the branching condition for executing the designated execution path is not approved, the execution path is branched to the middle of the partial code. Therefore, even in the case where the branching condition for executing the designated execution path is not approved, it is possible to improve the execution speed compared to the case where it is executed from the start point of the partial code.

(15) There is also such an embodiment in the compiler apparatus of (14) described above that the compiler apparatus further comprises a confluence definition variable replacing device and a confluence definition variable guarantee code generator, wherein:
the confluence definition variable replacing device replaces a defined point and a referred point of the variable with another variable, when there exists a variable defined in a basic block where controls interflow, in a partial instruction string containing a branch instruction in a middle thereof that constitutes the source program and the confluence definition variable guarantee code generator generates a guarantee code for restoring the another variable that is replaced to an original variable by the confluence definition variable replacing device and is necessary to be present at the exit of the partial instruction string, at an exit of the partial instruction string.

If it is constituted like this, the instruction present within the basic block where the controls interflows in the partial instruction string can be moved on the designated execution path without restrictions. Thus, parallel execution of the instructions can be facilitated further so as to improve the execution speed.

(16) There is also such an embodiment in the compiler apparatus of (15) described above that the compiler apparatus further comprises a first execution path conversion judging device, wherein the first execution path conversion judging device judges whether or not the program after executing the parallelizing device is taken as the object codes, based on the execution probability of the designated execution path.

If it is constituted like this, as in the case of the structure of (3), it is possible to shorten the processing time by selecting the program after executing the parallelizing device as the object codes, when the execution probability of the designated execution path is larger than a threshold value. Inversely, when the execution probability of the designated execution path is equal to or less than the threshold value, it is also possible to shorten the processing time through selecting the original program as the object codes without executing the parallelizing device.

(17) There is also such an embodiment in the compiler apparatus of (16) described above that the compiler apparatus further comprises a second execution path conversion judging device, wherein the second execution path conversion judging device:
calculates average execution time of the partial code, based on an execution probability of the designated execution path and execution time of the partial code;
calculates average execution time of the execution path after executing the parallelizing device, based on the execution probability of the designated execution path and execution time of the object codes on the execution path after executing the parallelizing device; and
judges whether or not the program after executing the parallelizing device is taken as the string of object codes, based on a comparison between the average execution time of the partial code and the average execution time of the execution path after executing the parallelizing device.

If it is constituted like this, as in the case of the structure of (4), it is possible to shorten the processing time more securely through selecting the program after execution of the parallelizing device as the object codes, when the average execution time on the execution path after execution of the parallelizing device is shorter than the average execution time of the partial code.

(18) Further, a compiler apparatus according to the present invention is an apparatus for converting a source program that includes a branching instruction into an object program that is a string object codes. The apparatus comprises
an execution path designating device, a first execution path code generator, a first guarantee code generator, a second execution path code generator, a confluence definition variable replacing device, a confluence definition variable guarantee code generator, a third execution path code generator, a second guarantee code generator, a partial code generator, a first branch code generator, a second branch code generator, a third branch code generator, a dependency analyzer, and a parallelizing device, wherein:
the execution path designating device designates a single execution path from a plurality of execution paths contained in a partial instruction string including a branching instruction in a middle thereof, that constitutes the source program;
the first execution code generator generates a first execution path code that is an object code corresponding to an entire instruction string on an execution path designated by the execution path designating device, and obtained by replacing a variable, that is necessary to be present at an entrance of the designated execution path and is defined on an execution path designated by the execution path designating device, with first another variable;
the first guarantee code generator generates a first guarantee code for restoring the first another variable, that is necessary to be present at an exit of the designated execution path, to an original variable;
the second execution path code generator copies the code string and replaces the variable that often holds the specific value in the copied code string with a value held by the variable, when a variable referred to in a code string generated by the first execution path code generator and the first guarantee code generator often holds a specific value, and generates a second execution path code that is obtained by inserting a conditional branching instruction where a condition is set to branch towards outside of the designated execution path, at a head of the code string, when the variable referred to in the code string holds a value different from the replaced value;
the confluence definition variable replacing device replaces a defined point and a reference point of a variable with second another variable, when there exists such variable defined in a basic block where controls interflow in the partial instruction string;
the confluence definition variable guarantee code generator generates, at an exit of the partial instruction string, a variable guarantee code for restoring the second another variable, that is necessary to be present at the exit of the partial instruction string, to an original variable;
the third execution path code generator generates a third execution path code that is an object code corresponding to an entire instruction string on the execution path designated by the execution path designating device after executing the confluence definition variable replacing device and the confluence definition variable guarantee code generator, and obtained by replacing a variable, that is necessary to be present at an entrance of the designated execution path and is defined on the designated execution path, with third another variable;
the second guarantee code generator generates a second guarantee code for restoring the third another variable, that is necessary to be present at an exit of the designated execution path, to an original variable;
the partial code generator generates a partial code that corresponds to the partial instruction string after executing the confluence definition variable replacing device and the confluence definition variable guarantee code generator;
the first branch code generator generates a first branch code based on a condition of a conditional branching instruction in the third execution path code, so that a branching destination of the conditional branching instruction in the third execution path code becomes a branching destination in a case where the branching condition in the partial code is not approved, when the branching condition for executing the designated execution path is not approved;
the second branch code generator generates a second branch code that branches to a start point of the third execution path code in the branching instruction within the first execution path code, when a branching condition for executing the designated execution path is not approved, based on a condition of a conditional branching instruction in the first execution path code;
the third branch code generator generates a third branch code that branches to a start point of the first execution path code in the branching instruction within the second execution path code, when a branching condition for executing the designated execution path is not approved, based on a condition of a conditional branching instruction in the second execution path code;
the dependency analyzer calculates a dependency relation between instructions based on an analysis of a dependency relation between the instructions in each of code strings generated by the first execution path code generator, the first guarantee code generator, the second execution path code generator, the third execution path code and the second guarantee code generator; and
the parallelizing device rearranges the instructions on the designated execution path based on the dependency relation between the instructions calculated by the dependency analyzer.

This corresponds to the combination of a plurality of technical contents described above, so that it is possible to shorten the processing time in an almost idealistic manner.

(19) A compiler method according to the present invention corresponds to the compiler apparatus of (1) described above. It is a compiler method for converting a source program that includes a branching instruction into an object program that is a string of object codes, and the method comprises steps of:
an execution path designating step for designating a single execution path from a plurality of execution paths contained in a partial instruction string including a branching instruction in a middle thereof, that constitutes the source program;
a first execution code generating step for generating a first execution path code by replacing a variable, that is defined on an execution path designated in the execution path designating step and is necessary to be present at an entrance of the designated execution path, with another variable;
a guarantee code generating step for generating a guarantee code for restoring the another variable, that is replaced in the first execution path code generating step and is necessary to be present also at an exit of the designated execution path, to an original variable;
a partial code generating step for generating a partial code that corresponds to the partial instruction string;
a first branch code generating step for generating a first branch code that branches to a start point of the partial code in the conditional branching instruction on the designated execution path, when a branching condition for executing the designated execution path is not approved, based on a condition of a conditional branching instruction on the designated execution path;
a first dependency analyzing step for calculating a dependent relation between instructions based on an analysis of a dependency relation between instruction on the designated execution path, adding a dependency between the guarantee code and the branch code that corresponds to the conditional branching instruction on the designated execution path so that the guarantee code is executed later than the conditional branching instruction of the designated execution path, and adding a dependency between the instructions lest any exception is generated; and
a parallelizing step for rearranging the instructions on the designated execution path based on the dependencies between the instructions added in the first dependency analyzing step.

(20) There is also such an embodiment in the compiler method of (19) described above that the method further comprises:
a return point setting instruction code generating step for adding an instruction code for specifying a return point on the designated execution path when an exception is generated during execution on the designated execution path; and
a second dependency analyzing step for adding a dependency between the guarantee code and the branch code that corresponds to the conditional branching instruction on the designated execution path so that the guarantee code is executed later than the conditional branching instruction on the designated execution path, based on an analysis of a dependency relation between the instructions on the designated execution path, wherein
There is such an embodiment that the second dependency analyzing step does not add the dependency, that is added between the instructions by the first dependency analyzing step lest an exception is generated. This corresponds to the compiler apparatus of (5) described above.

(21) There is also such an embodiment in the compiler method of (20) described above that the method further comprises a processing routine adding step at generation of interruption, that adds a processing routine for returning to the return point designated by the instruction code, to the object codes, when an exception is generated. This corresponds to the compiler apparatus of (6) described above.

(22) Further, a compiler method according to the present invention is a method for converting a source program that includes a branching instruction into an object program that is a string of object codes, and the method comprises steps of:
an execution path designating step for designating a single execution path from a plurality of execution paths contained in a partial instruction string including a branching instruction in a middle thereof, which constitutes the source program;
a first execution code generating step for generating a first execution path code that is an object code corresponding to an entire instruction string on an execution path designated by the execution path designating step, and obtained by replacing a variable, which is necessary to be present at an entrance of the designated execution path and is defined on the execution path designated by the execution path designating device, with first another variable;
a first guarantee code generating step for generating a first guarantee code for restoring the first another variable, which is necessary to be present at an exit of the designated execution path, to an original variable;
a second execution path code generating step copies the code string and then replaces the variable that often holds the specific value in the copied code string with a value held by the variable, when a variable referred to in a code string that is generated by the first execution path code generating step and the first guarantee code generating step often holds a specific value, and generates a second execution path code that is obtained by inserting a conditional branching instruction where a condition is set to branch towards outside of the designated execution path, at a head of the code string, when the variable referred to in the code string holds a value different from the replaced value;
a confluence definition variable replacing step for replacing a defined point and a reference point of a variable with second another variable, when there exists such variable defined in a basic block where controls interflow in the partial instruction string;
a confluence definition variable guarantee code generating step for generating a variable guarantee code for restoring the second another variable to the original variable, with respect to the second another variable that is necessary to be present at the exit of the partial instruction string;
a third execution path code generating step for generating a third execution path code that is an object code corresponding to an entire instruction string on the designated execution path after execution of the confluence definition variable replacing step and the confluence definition variable guarantee code generating step, and obtained by replacing a variable, which is necessary to be present at an entrance of the designated execution path and is defined on the designated execution path, with third another variable;
a second guarantee code generating step for generating a second guarantee code for restoring the third another variable, which is necessary to be present at an exit of the designated execution path, to an original variable;
a partial code generating step for generating a partial code that corresponds to the partial instruction string after execution of the confluence definition variable replacing step and the confluence definition variable guarantee code generating step;
a first branch code generating step which generates a first branch code so that a branching destination of the conditional branching instruction on the third execution path becomes a branching destination in a case where the branching condition in the partial code is not approved, when the branching condition for executing the designated execution path is not approved, based on a condition of a conditional branching instruction in the third execution path code;
a second branch code generating step which generates a second branch code that branches to a start point of the third execution path code in the branching instruction in the first execution path code, when a branching condition for executing the designated execution path is not approved, based on a condition of a conditional branching instruction in the first execution path code;
a third branch code generating step which generates a third branch code that branches to a start point of the first execution path code in the branching instruction in the second execution path code, when a branching condition for executing the designated execution path is not approved, based on a condition of a conditional branching instruction in the second execution path code;
a dependency analyzing step which calculates a dependency relation between instructions based on an analysis of a dependency relation between the instructions in each of code strings which are generated by the first execution path code generating step, the first guarantee code generating step, the second execution path code generating step, the third execution path code generating step and the second guarantee code generating step; and

a parallelizing step for rearranging the instructions on the designated execution path based on the dependency relation between the instructions calculated by the dependency analyzing step. This corresponds to the compiler apparatus of (18) described above.

(23) A compiler program according to the present invention corresponds to the compiler method of (19) described above. It is a compiler program for converting a source program that includes a branching instruction into an object program that is a string of object codes. The method allows a computer to execute steps of:
an execution path designating step for designating a single execution path from a plurality of execution paths contained in a partial instruction string including a branching instruction in a middle thereof, which constitutes the source program;
a first execution code generating step for generating a first execution path code by replacing a variable, that is defined on an execution path designated by the execution path designating step and is necessary to be present at an entrance of the designated execution path, with another variable;
a guarantee code generating step for generating a guarantee code for restoring the another variable, which is replaced by the first execution path code generating step and is necessary to be present also at an exit of the designated execution path, to an original variable;
a partial code generating step for generating a partial code that corresponds to the partial instruction string;
a first branch code generating step for generating a first branch code that branches to a start point of the partial code in the conditional branching instruction on the designated execution path, when a branching condition for executing the designated execution path is not approved, based on a condition of a conditional branching instruction on the designated execution path;
a first dependency analyzing step which calculates a dependency relation between instructions based on an analysis of a dependency relation between the instructions on the designated execution path, and also adds a dependency between the guarantee code and the branch code that corresponds to the conditional branching instruction on the designated execution path so that the guarantee code is executed later than the conditional branching instruction on the designated execution path, and adds a dependency between instructions lest any exception is generated; and
a parallelizing step for rearranging the instructions on the designated execution path based on the dependencies between the instructions added in the first dependency analyzing step.

(24) There is also such an embodiment in the compiler program of (23) described above that the program further comprises, as steps for the computer to execute:
a return point setting instruction code generating step for adding an instruction code for specifying a return point on the designated execution path when an exception is generated during execution of the designated execution path; and
a second dependency analyzing step which adds a dependency between the guarantee code and the branch code that corresponds to the conditional branching instruction on the designated execution path so that the guarantee code is executed later than the conditional branching instruction on the designated execution path, based on an analysis of a dependent relation between the instructions on the designated execution path, wherein
the second dependency analyzing step does not add a dependency, which is added between the instructions by the first dependency analyzing step lest an exception is generated. This corresponds to the compiler method of (20) described above.

(25) There is also such an embodiment in the compiler program of (24) described above that the program further comprises, as a step for the computer to execute, a processing routine adding step at generation of interruption, which adds a processing routine for returning to the return point designated by the instruction code, to the object codes, when an exception is generated. This corresponds to the compiler method of (21) described above.

(26) Furthermore, a compiler program according to the present invention is a method for converting a source program that includes a branching instruction into an object program that is a string of object codes. The method allows a computer to execute steps of:
an execution path designating step for designating a single execution path from a plurality of execution paths contained in a partial instruction string including a branching instruction in a middle thereof, which constitutes the source program;
a first execution code generating step for generating a first execution path code that is an object code corresponding to an entire instruction string on an execution path designated by the execution path designating step, and obtained by replacing a variable, which is necessary to be present at an entrance of the designated execution path and is defined on an execution path designated by the execution path designating device, with first another variable;
a first guarantee code generating step for generating a first guarantee code for restoring the first another variable, which is necessary to be present at an exit of the designated execution path, to an original variable;
a second execution path code generating step which copies the code string and then replaces the variable that often holds the specific value in the copied code string with a value held by the variable, when a variable referred to in a code string that is generated by the first execution path code generating step and by the first guarantee code generating step often holds a specific value, and generates a second execution path code that is obtained by inserting a conditional branching instruction where a condition is set to branch towards outside of the designated execution path, at a head of the code string, when the variable referred to in the code string holds a value different from the replaced value;
a confluence definition variable replacing step for replacing a defined point and a reference point of a variable with second another variable, when there exists such variable defined in a basic block where controls interflow in the partial instruction string;
a confluence definition variable guarantee code generating step for generating a variable guarantee code for restoring the second another variable to the original variable, at an exit of the partial instruction string, with respect to the second another variable that is necessary to be present at the exit of the partial instruction string;
a third execution path code generating step for generating a third execution path code that is an object code corresponding to an entire instruction string on the designated execution path after executing the confluence definition variable replacing step and the confluence definition variable guarantee code generating step, and obtained by replacing a variable, which is necessary to be present at an entrance of the designated execution path and is defined on the designated execution path, with third another variable;
a second guarantee code generating step for generating a second guarantee code for restoring the third another variable, which is necessary to be present at an exit of the designated execution path, to an original variable;
a partial code generating step for generating a partial code that corresponds to the partial instruction string after execution of the confluence definition variable replacing step and the confluence definition variable guarantee code generating step;
a first branch code generating step which generates a first branch code so that a branching destination of the conditional branching instruction on the third execution path becomes a branching destination in a case where the branching condition in the partial code is not approved, when the branching condition for executing the designated execution path is not approved, based on a condition of a conditional branching instruction in the third execution path code;
a second branch code generating step which generates a second branch code that branches to a start point of the third execution path code in the branching instruction in the first execution path code, when a branching condition for executing the designated execution path is not approved, based on a condition of a conditional branching instruction in the first execution path code;
a third branch code generating step which generates a third branch code that branches to a start point of the first execution path code in the branching instruction in the second execution path code, when a branching condition for executing the designated execution path is not approved, based on a condition of a conditional branching instruction in the second execution path code;
a dependency analyzing step which calculates a dependency relation between instructions based on an analysis of a dependent relation between the instructions in each of code strings which are generated by the first execution path code generating step, the first guarantee code generating step, the second execution path code generating step, the third execution path code generating step and the second guarantee code generating step; and

a parallelizing step for rearranging the instructions on the designated execution path based on the dependency relation between the instructions calculated by the dependency analyzing step. This corresponds to the compiler method of (21) described above.

Further, the compiler apparatus according to the present invention may have an interpreter function for executing the source program sequentially, and may comprise a path extracting device which collects the information of the execution path in the partial instruction string by the use of the interpreter function and extracts the execution path that is executed with high frequency, wherein the execution path designating device designates the execution path that is extracted by the extracting device. Furthermore, the compiler apparatus may comprise a value extracting device which collects the information of the value held by the variable that is referred to on the execution path with high execution frequency by the use of the interpreter function, and extracts the value that appears with high frequency, and the extracted variable and the value may be used in the execution path code generator.

If it is constituted like this, it is possible to obtain more accurate information on the execution path with high execution frequency and information on the value held by the variable, which correspond much more to the operation mode at the time of execution, from the interpreter. Therefore, it is possible to improve the execution speed compared to the case where the information is given to the compiler by user's designation or with specific empirical values.

According to the present invention, it is possible to achieve optimization more effectively because the basic block on the designated execution path is extended and also the target range of scheduling is expanded. Further, this structure is constituted so that the instruction sentence on the execution path is executed preferentially and there is no branching contained in the middle of the execution path. Therefore, it is possible to improve the execution speed of the execution path when the execution probability of the execution path is higher than that of other execution paths.

Further, since the instruction on the hot path, which is possible to generate an exception, can be moved on the hot path without restrictions, parallel execution of the instructions can be facilitated further. As a result, the execution speed can be improved.

Furthermore, since the variables on the execution path can be replaced with the constant value, the chance to perform constant value propagation optimization is increased. Herewith, the execution speed can be improved further.

Moreover, when the branching condition for executing the designated execution path is not approved, the execution path is branched to the middle of the partial code. Therefore, even in the case where the branching condition for executing the designated execution path is not approved, it is possible to improve the execution speed compared to the case where it is executed from the start point of the partial code.

Further, it is possible to obtain more accurate information on the execution path with high execution frequency and information on the value held by the variable, which correspond much more to the operation mode at the time of execution, from the interpreter. Therefore, it is possible to improve the execution speed compared to the case where the information is given to the compiler by user's designation or with specific empirical values.

The compiler apparatus, the compiler method, and the compiler program according to the present invention are capable of converting the program containing a plurality of execution paths so as to improve the execution speed of the execution path that is executed with high frequency. Therefore, the compiler apparatus, the compiler method and the compiler program of the present invention can be used by being loaded to the information processors of digital home electrical appliances and the like.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a functional constitution diagram of a compiler apparatus according to an embodiment of the present invention;

FIG. 2 is an operation flowchart of the compiler apparatus according to the embodiment of the present invention;

FIG. 3 is a flow of variable information calculating processing performed by a variable information calculating part;

FIG. 4 is a flow of variable replacing processing performed by an execution path intermediate code generating part;

FIG. 5A and FIG. 5B are illustrations used for describing the operation of the compiler apparatus according to the embodiment of the present invention;

FIG. 6 is an illustration used for describing a conventional technique and the issues thereof;

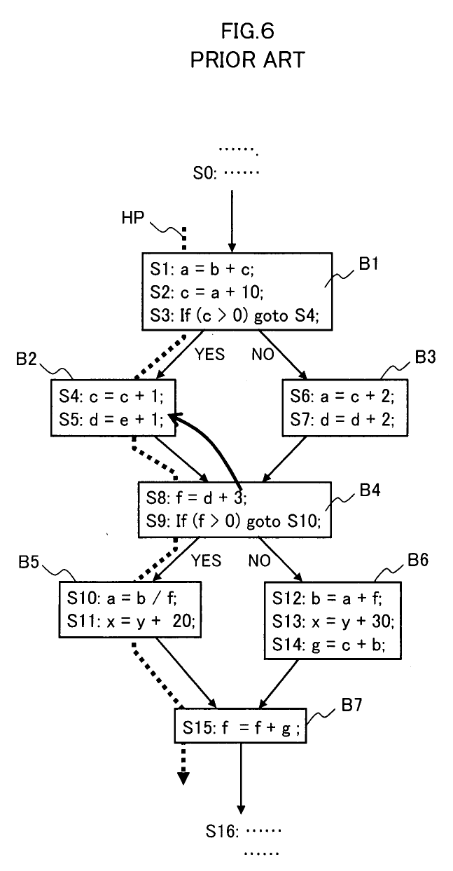

FIG. 7 is an illustration used for describing the conventional technique and the issues thereof;

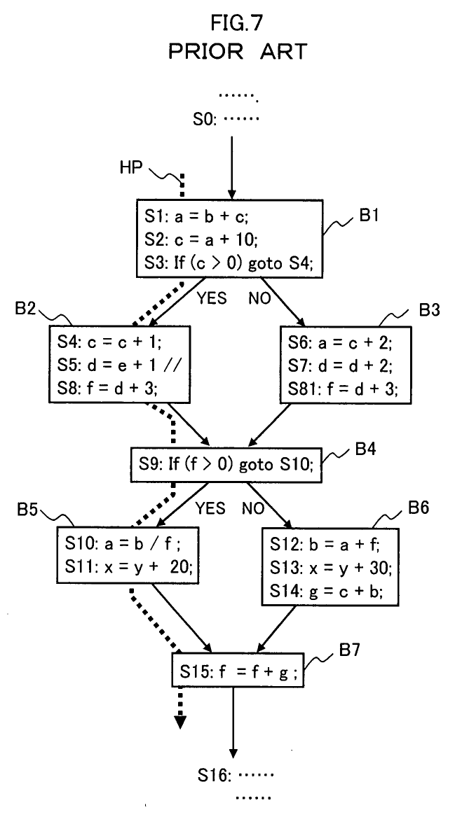

FIG. 8 is an illustration used for describing the conventional technique and the issues thereof;

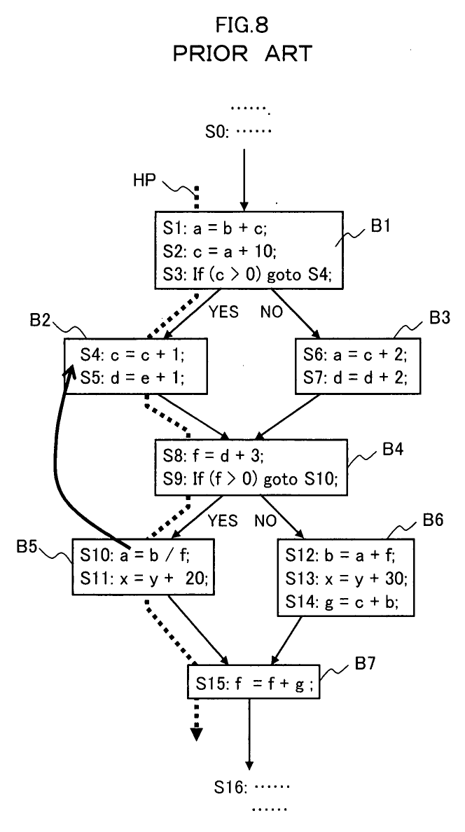

FIGS. 9A-9C are illustrations showing variable information calculated by the variable information calculating part, and the structure and contents example of generation history of variable pairs that are generated by the execution path intermediate code generating part;

FIG. 10 is an illustration used for describing the operation of the compiler apparatus according to the embodiment of the present invention;

FIG. 11 is an illustration used for describing the operation of the compiler apparatus according to the embodiment of the present invention;

FIG. 12 is an illustration for dependency analysis information that is generated by an intermediate code dependency analyzing part;

FIG. 13 is an illustration of an execution path intermediate code to which instruction scheduling is performed by an intermediate code parallelizing part;

FIG. 14 is an illustration used for describing the operation of a compiler apparatus according to Modification Example 1;

FIG. 15 is an illustration for dependency analysis information that is generated by an intermediate code dependency analyzing part according to Modification Example 1;

FIG. 16 is a diagram showing an execution path intermediate code to which instruction scheduling is performed by an intermediate code parallelizing part according to Modification Example 1;

FIG. 17 is an illustration showing the operation of an object program according to Modification Example 1, when an exception is generated;

FIG. 18 is an illustration used for describing the operation of a compiler apparatus according to Modification Example 2;

FIG. 19 is an illustration for dependency analysis information that is generated by an intermediate code dependency analyzing part according to Modification Example 2;

FIG. 20 is an illustration of an execution path intermediate code to which instruction scheduling is performed by an intermediate code parallelizing part according to Modification Example 2;

FIG. 21 is an illustration used for describing the operation of a compiler apparatus according to Modification Example 3;

FIG. 22 is an illustration of an execution path intermediate code to which instruction scheduling is performed by an intermediate code parallelizing part according to Modification Example 3;

FIG. 23 is a functional constitution diagram of a compiler apparatus according to Modification Example 4;

FIG. 24 is an operation flowchart of the compiler apparatus according to Modification Example 4;

FIG. 25A and FIG. 25B are illustrations used for describing the operations of the compiler apparatus according to Modification Example 4;

FIG. 26 is an illustration used for describing the operation of the compiler apparatus according to Modification Example 4;

FIGS. 27A-27C are diagrams showing variable information calculated by the variable information calculating part, and the structure and contents example of pair generation history of variable pairs that are generated by the execution path intermediate code generating part according to Modification Example 4;

FIG. 28 is an illustration used for describing the operation of the compiler apparatus according to Modification Example 4;

FIG. 29 is an illustration used for describing the operations of the compiler apparatus according to Modification Example 4;

FIG. 30 is an illustration for dependency analysis information that is generated by an intermediate code dependency analyzing part according to Modification Example 4;

FIG. 31 is an illustration of an execution path intermediate code to which instruction scheduling is performed by an intermediate code parallelizing part according to Modification Example 4;

FIG. 32 is an illustration used for describing the operation of the compiler apparatus according to Modification Example 4;

FIG. 33 is an illustration used for describing the operations of the compiler apparatus according to the embodiment of the present invention;

FIG. 34 is an illustration used for describing the operations of the compiler apparatus according to the embodiment of the present invention;

FIG. 35 is an illustration used for describing the operations of the compiler apparatus according to the embodiment of the present invention; and

FIGS. 36A-36C are illustrations used for describing the operations of the compiler apparatus according to Modification Example of the present invention.

### DETAILED DESCRIPTION OF THE INVENTION

Hereinafter, preferred embodiment of the present invention will be described referring to the accompanying drawings.

### Embodiment

A compiler apparatus according to an embodiment of the present invention: reads a source program; performs word/phrase analysis to resolve the program into word/phrase strings; performs a syntax analysis for creating a syntax tree in a programming language based on the word/phrase strings; creates an intermediate program that is written with intermediate codes inside the apparatus based on the syntax tree created by the syntax analysis; performs optimization such as instruction scheduling for the intermediate program; and converts the intermediate program after allocation of resources such as registers are performed with respect to variables, into an execution format program.

(Structure)

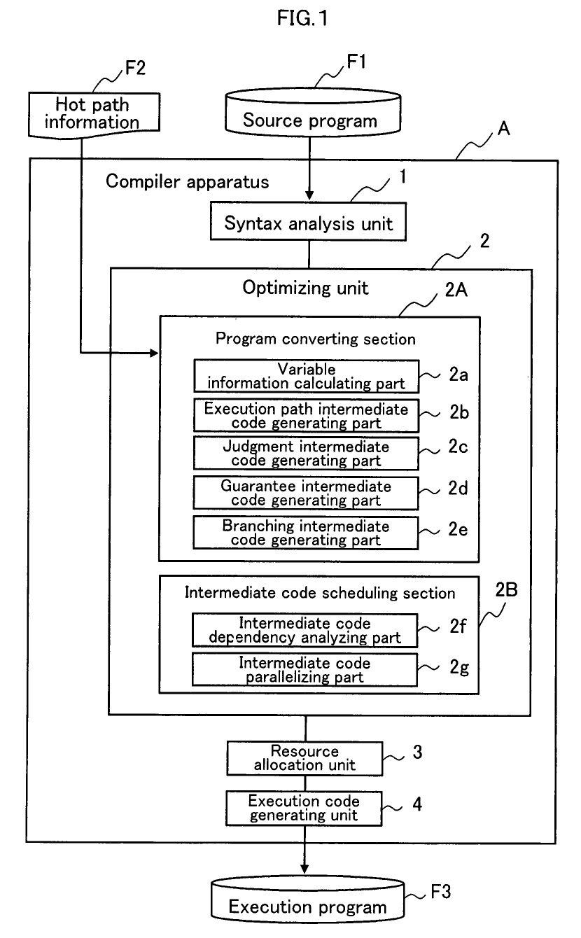

FIG. 1 is a functional block diagram showing the entire structure of a compiler apparatus A according to the embodiment of the present invention. The compiler apparatus A comprises a syntax analysis unit 1, an optimizing unit 2, a resource allocation unit 3, and an execution code generating unit 4. Specifically, the compiler apparatus A is a computer system that is achieved by using a microprocessor, a ROM (Read Only Memory), a RAM (Random Access Memory), a hard disk device and the like. The ROM or the hard disk device stores computer programs. Functions of each part of the compiler apparatus A shown in FIG. 1 can be achieved when the microprocessor executes the computer programs. Further, information can be stored and exchanged between each of the parts by using the RAM and the hard disk device.

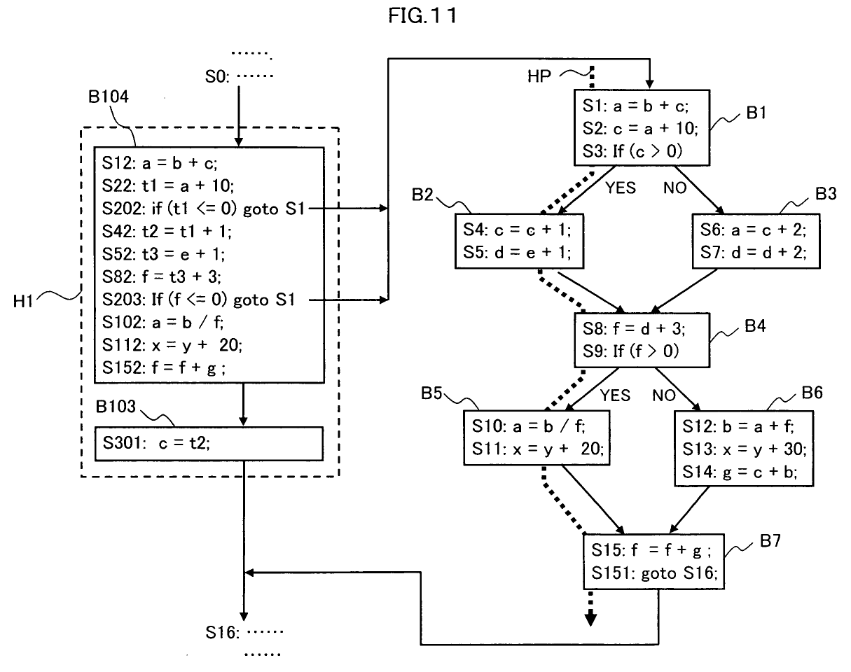

Functions of each part will be described hereinafter. The syntax analysis unit 1 reads out a source program F1, performs syntax analysis to recognize the control structure inside the source program F1, generates an intermediate program that is a string of intermediate codes, and stores it within the compiler apparatus A. The control structure of the intermediate program is expressed by using a conditional branching intermediate code, a branching intermediate code, and a label intermediate code, so that it becomes the control structure equivalent to that of the source program F1. The conditional branching intermediate code is constituted with a judgment intermediate code (for example, t1<=0 of S202 in FIG. 11) that shows the judgment on the condition, and the branching intermediate code (for example, goto S1 of S203 in FIG. 11) that indicates the branching destination for the case where the judgment on the condition is true.

The optimizing unit 2 is constituted through including a program converting section 2A and an intermediate code scheduling section 2B. The optimizing unit 2 performs control flow analysis and dataflow analysis of the intermediate program generated in the syntax analysis unit 1, and outputs the results of the analyses to the program converting section 2A that is described later. The control flow analysis is performed to divide the intermediate program into basic blocks through analyzing the control flow of the intermediate program. The dataflow analysis is performed to analyze the existence period, the defined point, and the reference point of the variable.

Definition and reference with respect to the variable is determined as stated below. When the value of the variable in the intermediate code is updated, it is expressed as “the variable in that intermediate code is defined”, and the intermediate code is referred to as a defined point of the variable. Further, when the value of the variable in the intermediate code is used, it is expressed as “the variable is referred to in the intermediate code”, and the intermediate code is usually regarded as a referred point of the variable.

Next, the program converting section 2A will be described. The program converting section 2A comprises a variable information calculating part 2a, an execution path intermediate code generating part 2b, a judgment intermediate code generating part 2c, a guarantee intermediate code generating part 2d and a branching intermediate code generating part 2e.

When hot path information F2 is inputted to the apparatus from the outside, the program converting section 2A stores it in the inside of the program converting section 2A, and performs program conversion on the subroutine program including the hot path HP (designation of the execution path).

Here, the information indicating the execution path that a user determines in advance is inputted through the user as the hot path information F2. In the explanation of the embodiment, the subroutine program including the hot path is referred to as a partial program, and the partial program contains a plurality of execution paths that share the start point and end point of the hot path HP. Additionally, in the explanation of the embodiment, the intermediate code string corresponding to the partial program is usually regarded as a partial intermediate code string.

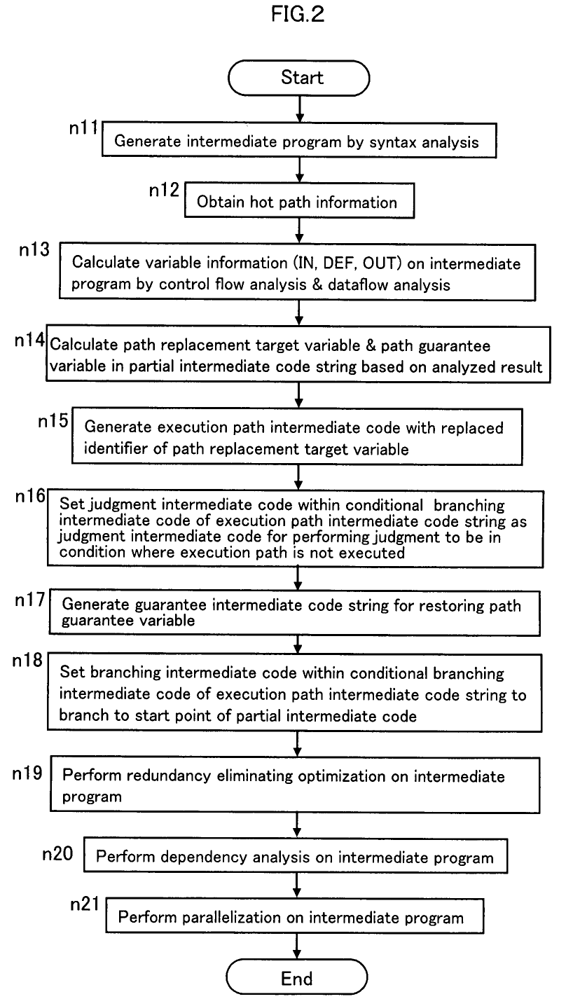

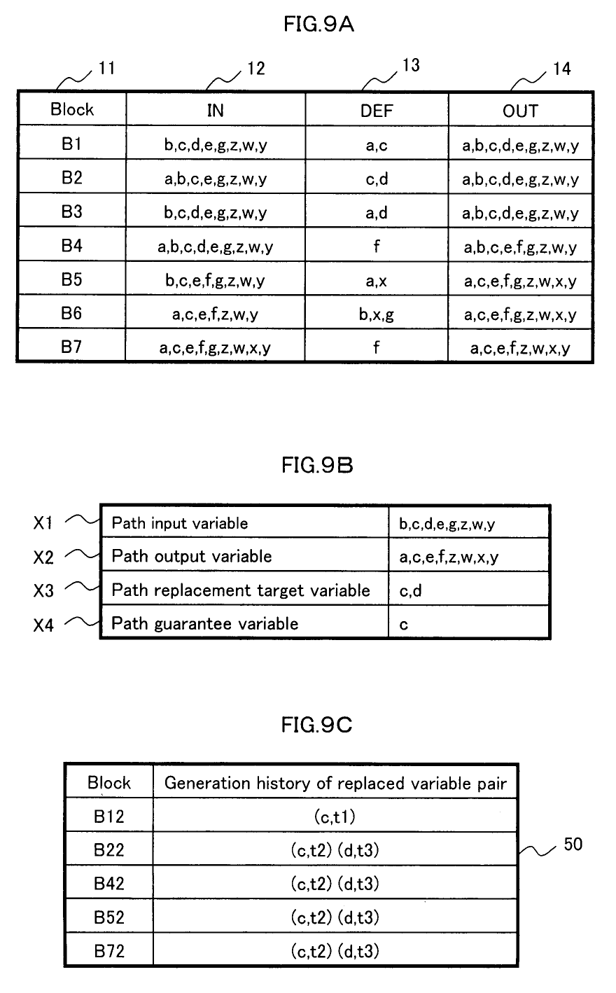

The variable information calculating part 2a calculates the existence information and defined information of the variables in each basic block based on the analyzed results sent out from the optimizing unit 2, and calculates a path input variable X1, a path output variable X2, a path replacement target variable X3, and a guarantee variable X4 (see FIG. 9B, for example) based on the calculated existence information and defined information and the hot path information F2 (see step n14 of FIG. 2). Further, the variable information calculating part 2a sends out the calculated path replacement target variable X3 to the execution path intermediate code generating part 2b, and sends out the path guarantee variable X4 to the guarantee intermediate code generating part 2d.

The variable existence information indicates the variable existing at an entrance that is a start point of each basic block generated by the control flow analysis (referred to as “existence information IN” hereinafter), and the variable existing at the exit that is an end point of each basic block (referred to as “existence information OUT” hereinafter). The existence information IN is a variable that is referred to before being defined on and after the entrance of the basic block, and the existence information OUT is a variable that is referred before being defined on and after the exit of the basic block. Further, the variable defined information (referred to as “defined information DEF” hereinafter) indicates a variable that is defined in each block. For the existence of the variables, it is the same as that described in Non-Patent Literature 2 described above.

The path input variable X1 is the variable existing at the entrance of the hot path HP, which indicates the existing information IN in the basic block that is the start point of the hot path HP. The path output variable X2 is the variable existing at the exit of the hot path HP, which indicates the existing information OUT in the basic block that is the end point of the hot path HP.

The path replacement target variable X3 indicates a variable that is the path input variable X1 and is also defined on the hot path HP. The path guarantee variable X4 indicates a variable that is the path replacement target variable X3 and is also the path output variable X2.

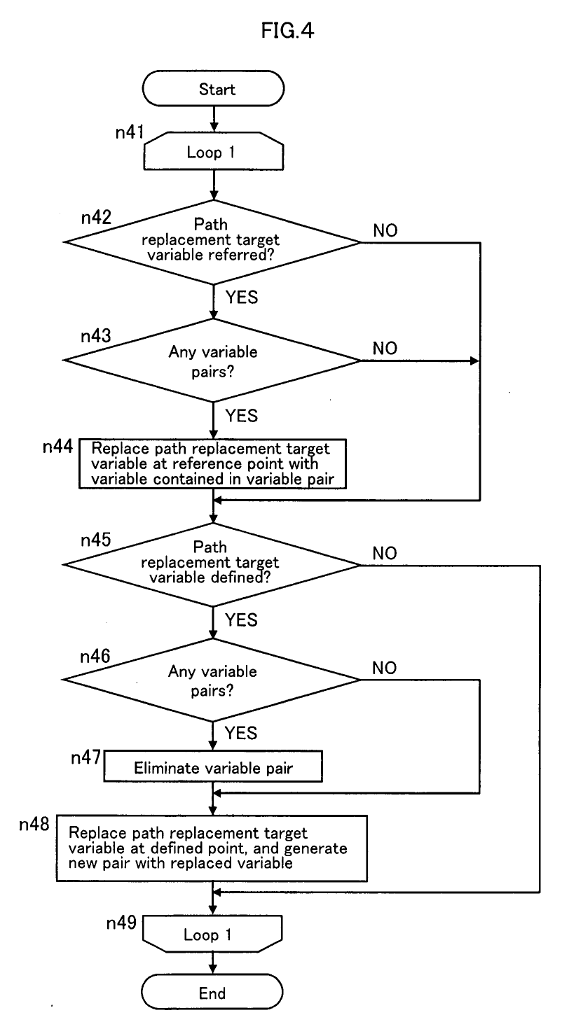

The execution path intermediate code generating part (first execution path code generator) 2b reads out the hot path information F2 stored in the program converting section 2A and the intermediate program stored within the compiler apparatus A. Then, with respect to the intermediate code string on the hot path HP of the intermediate program, the execution path intermediate code generating part 2b generates an execution path intermediate code string in which the identifier of the path replacement target variable X3 sent out from the variable information calculating part 2a is replaced, and sends out the generated execution path intermediate code string to the judgment intermediate code generating part 2c (see step n15 of FIG. 2, and FIG. 4).

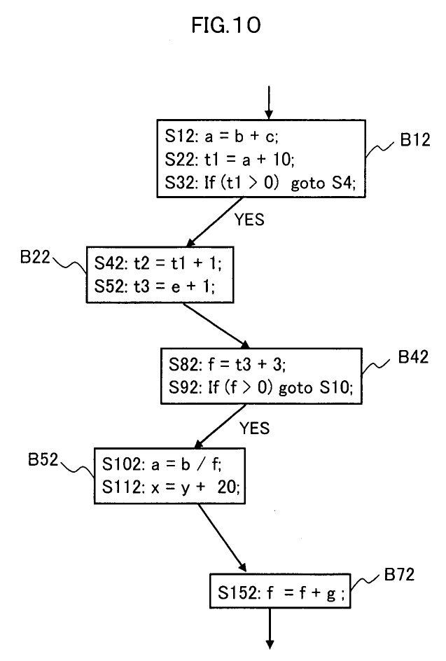

Replacement of the identifier of the path replacement target variable X3 will be described now. The execution path intermediate code generating part 2b replaces the identifier of the path replacement target variable X3 with an identifier that is not in a variable name table where the information concerning the identifiers and the like of the variables are shown. The execution path intermediate code generating part 2b generates a variable pair replaced with the path replacement target variable X3 just as replacement of variable, and stores the generated variable pair inside the program converting section 2A. The variable name table is the one wherein information concerning the identifiers and types and the like of the variables, which are declared on the program at the time of word/phrase analysis, is collected, and it is stored in the compiler apparatus A. For the replacement of the identifier of the path replacement target variable X3, t1-t3 of FIG. 10 can be referred to. Further, FIG. 9C and step n48 of FIG. 4 can be referred to for the pair of the replaced variables.

The judgment intermediate code generating part (partial code generator) 2c sets the judgment intermediate code in the conditional branching intermediate code contained in the execution path intermediate code string transmitted from the execution path intermediate code generating part 2b so as to be a condition where the hot path HP is not executed, and stores the converted execution path intermediate code string in the inside the program converting section 2A. In addition, in setting the condition where the hot path HP is not executed, it is possible to refer to the shift from S202, S203 to B1 shown in FIG. 11.

The guarantee intermediate code generating part (guarantee code generator) 2d generates a guarantee intermediate code string that is the intermediate code string for restoring the identifier of the path guarantee variable X4 to the original identifier based on the path guarantee variable X4 sent out from the variable information calculating part 2a. Then, the guarantee code generating part 2d arranges it immediately after the execution path intermediate code string, and stores it in the inside the program converting section 2A (see S301 of FIG. 11). Here, the intermediate code string constituted with the execution path intermediate code string and the guarantee intermediate code string is referred to as a high-speed block (see H1 of FIG. 11). The high-speed block H1 is characterized that there is no branching toward the inside the high-speed block H1 even though there is a branching towards the outside the high-speed block from the middle of the high-speed block H1 in the conditional branching intermediate code.

The branching intermediate code generating part (first branch code generator) 2e reads out the conditional branching intermediate code contained in the execution path intermediate code string of the program converting section 2A. When the condition of the judgment intermediate code in the conditional branching intermediate code is true, the branching intermediate code generating part 2e sets the branching intermediate code of the conditional intermediate code as the branching intermediate code that branches to the start point of the partial intermediate code and, at the same time, stores the execution path intermediate code string in the inside the program converting section 2A. Further, the branching intermediate code generating part 2e sets the partial intermediate code string stored in the compiler apparatus A as a subroutine. That is, the branching intermediate code that branches to the intermediate code shortly after the end point of the partial intermediate code string is inserted to the end point of the partial intermediate code string. Further, the branching intermediate code generating part 2e arranges the high-speed block H11 stored inside the program converting section 2A at a position between the point soon after the intermediate code that is immediately before the start point of the partial intermediate code string and the point soon before the intermediate code that is immediately after the end point of the partial intermediate code. Then, the branching intermediate code generating part 2e stores the partial intermediate code processed in this manner (partial intermediate code string) in the inside the compiler apparatus 2A. The program structure shown in FIG. 11 can be referred to with regard to this. As for branching to the start point of the partial intermediate code, it is possible to refer to goto S1 in the program structure shown in FIG. 11. Further, it is possible to refer to S151 in the program structure of FIG. 11 with respect to the insertion of the branching intermediate code branching to the intermediate code soon after the end point of the partial intermediate code string.

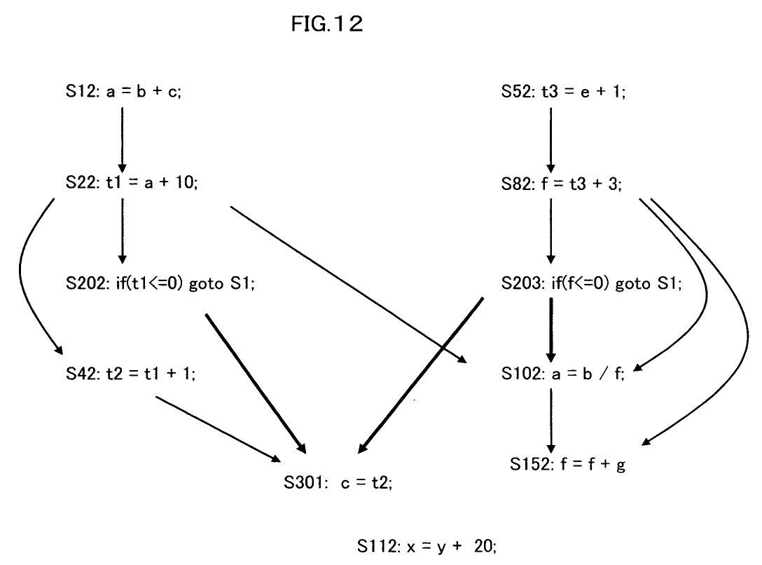

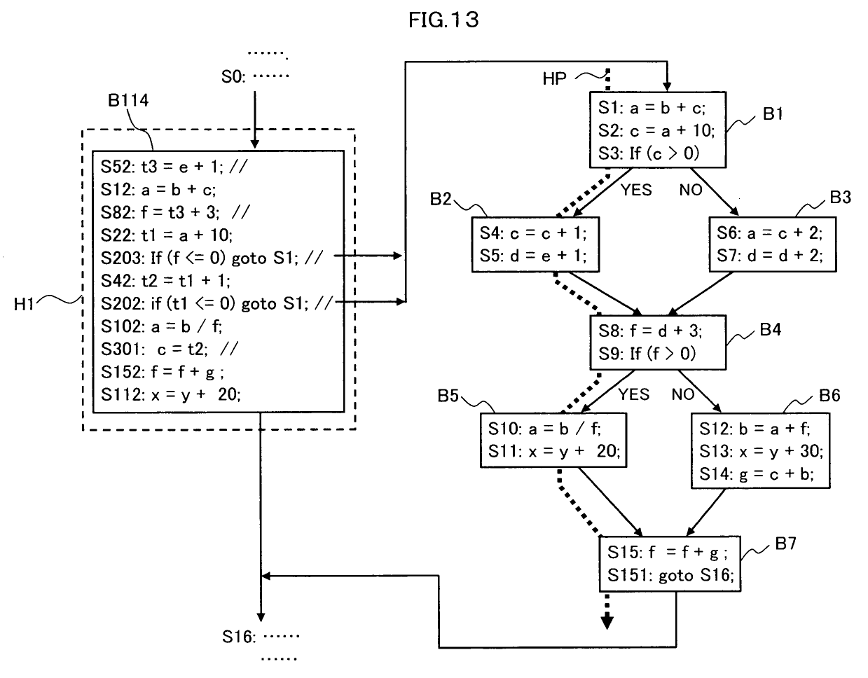

Next, the intermediate code scheduling section 2B will be described. The intermediate code scheduling section 2B reads out the intermediate program stored in the compiler apparatus A, and performs dependency analysis by the intermediate code dependency analyzing part 2f so as to determine the execution order between the intermediate code instructions. Further, intermediate code scheduling section 2B rearranges the intermediate codes of the intermediate program with the intermediate code parallelizing part 2g so as to enable parallel execution. FIG. 12 can be referred to as for the dependency analysis. Further, the change from the high-speed block H1 of FIG. 11 to the high-speed block H1 of FIG. 13 can be referred to as for rearrangement of the intermediate code.

In particular, the processing of the intermediate code dependency analyzing part 2f and the intermediate code parallelizing part 2g to the high-speed block H1 participated in the present invention will be described herein. Other parts employ the same method as those recited in Non-Patent Literature 1.

The intermediate code dependency analyzing part (first dependency analyzer) 2f analyzes the dependency relation between the intermediate codes in the intermediate code string within the high-speed block, and sends out the dependency analysis information that is the analyzed result to the intermediate code parallelizing part 2g. In the present invention, to set a specific dependency relation between the intermediate codes based on the above-described analysis and the like is expressed as generation of dependency. Even though the intermediate code dependency analyzing part 2f generates the same dependency as the ones recited in Non-Patent Literature 1 in relation to the regular operators, it generates a special dependency as for a part of intermediate codes. This will be described hereinafter.

First, the intermediate code dependency analyzing part 2f generates the dependency from the branching condition intermediate code to the guarantee intermediate code so that the branching condition intermediate code in the high-speed block H1 is executed before the execution of the guarantee intermediate code in the high-speed block H1. As for this, it is possible to refer to FIG. 12 where S202 and S203 are placed at higher positions than S301.

Secondly, the intermediate code dependency analyzing part 2f specifies an exception generating intermediate code that is an intermediate code possible to cause an exception, and an exception generating variable that is a cause for generating the exception. Further, the intermediate code dependency analyzing part 2f judges whether or not the judgment intermediate code for performing judgment by referring to the specified exception generating variable is executed prior to the exception generating intermediate code. When it is judged that the judgment intermediate code is executed prior to the exception generating intermediate code, the intermediate code dependency analyzing part 2f generates the dependency from the judgment intermediate code to the exception generating intermediate code so as to maintain the executing order. As for this, it is possible to refer to FIG. 12 where S203 is placed at a higher position than S102. Further, to induce an exception means to generate the state where the processing cannot be performed (i.e. exception), because a devisor f becomes 0 (zero-division) when a substitute sentence of S102 is executed prior to S203.

The intermediate code parallelizing part (parallelizing device) 2g performs parallelization by carrying out scheduling of the intermediate code string within the high-speed block H1 based on the dependency analysis information sent out from the intermediate code dependency analyzing part 2f (see FIG. 13). Here, as a scheduling method, it is possible to apply the list scheduling method recited in Non-Patent Literature 1.

The resource allocation unit 3 allocates the hardware resources such as a register and a memory to each variable based on the existence information of the variables in the whole intermediate codes, when reading out the generated whole intermediate codes and generating the execution codes from the intermediate codes. The execution code generating unit 4 converts the whole intermediate codes, to which the resources are allotted, into execution codes of a machine language, and outputs those execution codes to the outside the compiler apparatus.

<Data>

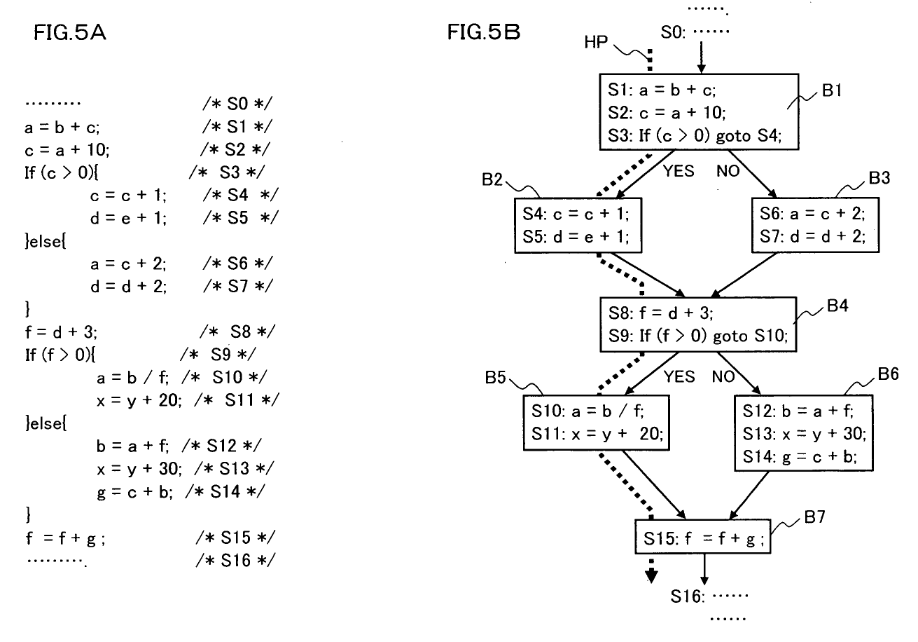

The data used in the compiler apparatus A according to the embodiment will be described. FIG. 9A shows the results where the variable information calculating part 2a has calculated IN12, OUT14 as the existence information of the variables, and DFF13 as the defined information by each basic block of the control flow graph shown in FIG. 5B. FIG. 9B shows the results where the variable information calculating part 2a has calculated the path input variable X1, the path output variable X2, the path replacement target variable X3 and the path guarantee variable X4 based on the calculation results shown in FIG. 9A. FIG. 9C shows the generation history of the variable pairs generated by replacing the variables with the path replacement target variables X3 with the execution path intermediate code generating part 2b in each basic block of the control flow graph shown in FIG. 5B. The control flow graph shown in FIG. 10 shows the execution path that is generated anew, based on a processing where the execution path intermediate code generating part 2b copies the intermediate code on the hot path HP of FIG. 5B and performs the variable replacing processing to the copied intermediate code.

<Operation>

Next, the operation flow shown in FIG. 2 will be described, with a focus on the operations inside the optimizing unit 2 that is a characteristic portion of the present invention.

First, when the source program F1 is inputted, the syntax analysis unit 1 performs syntax analysis to generate the intermediate program, and stores it to the inside the compiler apparatus A (step n11).

Then, upon receiving an input of the hot path information F2 (FIG. 1), the program converting section 2A stores the hot path information F2 to the inside thereof (step n12).

Following the step n12, the optimizing unit 2 reads out the intermediate program, performs the control flow analysis and the dataflow analysis on the read out intermediate program, and sends out the analyzed results to the variable information calculating part 2a. The variable information calculating part 2a calculates the existence information (IN, OUT) and the defined information (DEF) of the variables in each basic block of the partial program based on the analyzed results obtained by the optimizing unit 2 (step n13).

Then, the variable information calculating part 2a calculates the path input variable X1, the path output variable X2, the path replacement target variable X3 and the path guarantee variable X4 of the partial intermediate code string, based on the existence information (IN, OUT), the defined information DEF calculated in the step n13 and the hot path information F2 inputted in the step n12. The variable information calculating part 2a sends out the path replacement target variable X3 to the execution path intermediate code generating part 2b, and sends out the path guarantee variable X4 to the guarantee intermediate code generating part 2d (step n14).

Following the step n14, the execution path intermediate code generating part 2b reads out the hot path information F2 and the partial intermediate code string, and copies the intermediate string that corresponds to the hot path HP in the readout partial intermediate code string. Further, the execution path intermediate code generating part 2b generates an execution path intermediate code string by replacing the identifier of the path replacement target variable X3 in the copied intermediate code string, and sends out the generated execution path intermediate code string to the judgment intermediate code generating part 2c (step n15). Furthermore, the program of FIG. 10 can be referred to as for this. Replacement of the identifier of the path replacement target variable X3 corresponds to c→t1, c→t2, and d→t3.

Then, upon receiving the execution path intermediate code string, the judgment intermediate code generating part 2c sets the judgment intermediate code in the conditional branching intermediate code contained in the execution path intermediate code string to be the condition where the hot path is not executed, and stores the set judgment intermediate code to the inside the program converting section 2A (step n16).

The judgment intermediate code in the conditional branching intermediate code corresponds to the followings in the program of FIG. 10.

### S32: If (t1>0) goto S4

### S92: If (f>0) goto S10

“To set the judgment intermediate code to be the condition where the hot path is not executed” corresponds to the followings in the program of FIG. 11.

### S202: If (t1<=0) goto S1

### S203: If (f<=0) goto S1

Here, the logic of the judgment condition is inverted to change the destination to the start S1 of the partial intermediate code string of the subroutine from the lower stream. As a result, the hot path is not executed when the judgment condition after the logic inversion becomes positive.

Then, the guarantee intermediate code generating part 2d generates the guarantee intermediate code string for restoring the path guarantee variable X4 received from the variable information calculating part 2a, and stores it to the inside the program converting section 2A. Further, the guarantee intermediate code generating part 2d arranges the guarantee intermediate code string after the execution path intermediate code string to construct the high-speed block, and stores it in the inside the program converting section 2A (step n17). This corresponds to constructing the high-speed block H1 in the program of FIG. 11 by arranging the generated basic block B103 behind the basic block B104 after generation of the basic block B103 (S301: c=t2).

Following the step n17, the branching intermediate code generating part 2e reads out the conditional branching intermediate code in the execution path intermediate code string that is stored in the step n16. Then, branching intermediate code generating part 2e sets the branching intermediate code in the conditional branching intermediate code to be executed from the start point of the branching intermediate code, and stores the conditional branching intermediate code set like that in the inside the program converting section 2A. Furthermore, the branching intermediate code generating part 2e sets the partial intermediate code as a subroutine, and stores the result in the inside the compiler apparatus A (step n18).

In the program of FIG. 11, this corresponds to branch the respective branching intermediate codes of the conditional branching intermediate code S202 and the branching intermediate code S203 to the intermediate code S1 of the block B1 that is the start point of the partial program. The execution path intermediate code string corresponds to the string on the left side of FIG. 11, and the subroutine partial intermediate code corresponds to the string on the right side of FIG. 11.

Following the step n18, the optimizing unit 2 performs processing for eliminating redundancy of the intermediate program that is stored inside the compiler apparatus A. The optimizing unit 2 stores the intermediate program to which the processing for eliminating redundancy is performed in the inside the compiler apparatus A (step n19). The processing for eliminating redundancy is the same as the one recited in Non-Patent Literature described above, and an example thereof includes the processing performed to eliminate unproductive operations.

Following the step n19, the intermediate code dependency analyzing part 2f performs dependency analysis of the intermediate codes in the intermediate program that is stored inside the compiler apparatus A (see FIG. 12), and sends out the dependency analysis information as the analyzed result thereof to the intermediate code parallelizing part 2g. The intermediate code dependency analyzing part 2f performs dependency analysis particularly on the high-speed block H1 while considering the exception generating intermediate code described above (step n20).

Following the step n20, the intermediate code parallelizing part 2g parallelizes the intermediate program stored inside the compiler apparatus A, based on the dependency analysis information received from the intermediate code dependency analyzing part 2f.

<Variable Information Calculation Processing>

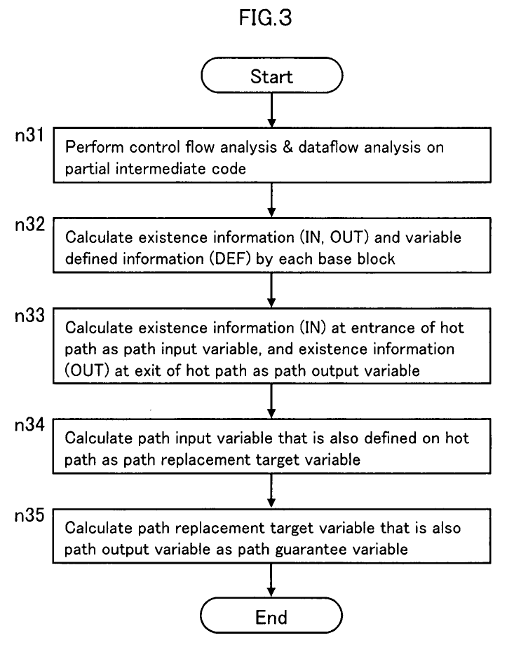

Next, the variable information calculation processing will be described referring to FIG. 3. This corresponds to the steps n13 and n14 of FIG. 2. In a step n31, the optimizing unit 2 performs the control flow analysis and the dataflow analysis of the partial intermediate code. Then, in a step n32, the variable information calculating part 2a calculates the existence information (IN, OUT) and the defined information (DEF) of the variables in the partial program based on the results of the control flow analysis and the dataflow analysis.

Subsequently, the variable information calculating part 2a assesses the existence information IN of the basic block that is the start point of the hot path as the path input variable X1, among the existence information IN calculated in the step n32, and the variable information calculating part 2a assesses the existence information OUT of the basic block that is the end point of the hot path as the path output variable X2, among the existence information OUT calculated in the step n32 (step n33).

Following the step n33, the variable information calculating part 2a assesses the variable that is the defined information DEF on the hot path HP and is also the path input variable X1 as the path replacement target variable X3 (step n34).

Subsequently, the variable information calculating part 2a assesses the variable that is the path replacement target variable X3 assessed in the step n34 and is also the path output variable X2 as the path guarantee variable X4, and sends out the path guarantee variable X4 and the path replacement target variable X3 to the execution path intermediate code generating part 2b (step n35).

<Variable Replacing Processing>

Upon receiving the data of the path replacement target variable X3 sent out from the variable information calculating part 2a, the execution path intermediate code generating part 2b reads out the partial intermediate code and the hot path information F2, copies the intermediate code that corresponds to the hot path HP of the partial intermediate code, and repeatedly performs the variable replacing processing to the path replacement target variable X3 of the copied intermediate code. Through performing the processing described above, the execution path intermediate code generating part 2b generates a pair of the path replacement target variable X3 and the variable after replacement that is obtained through the variable replacing processing (referred to as “variable pair” hereinafter). This corresponds to the step n15 of FIG. 2.

Hereinafter, the variable replacing processing performed by the execution path intermediate code generating part 2b will be described referring to FIG. 4. The variable replacing processing is repeatedly performed to the copied intermediate code (step n41). It is then judged whether or not the path replacement target variable X3 is referred to in the intermediate code (step n42). When it is judged in the step n42 that the path replacement target variable X3 is not referred to, the procedure is advanced to a step n45.

When it is judged in the step n42 that it is referred to, it is judged whether or not the path replacement target variable X3 is contained in the variable pair that has already been generated (step n43). When it is judged in the step n43 that the path replacement target variable X3 is not contained, the procedure is advanced to the step n45.

When it is judged in the step n43 that it is contained, the identifier of the path replacement target variable X3 that is referred to in the instruction sentence is replaced with the variable contained in the pair (step n44), and then the procedure is advanced to the step n45.

After performing the above-described processing (step n42-step n44), it is judged whether or not the path replacement target variable X3 is defined in the intermediate code (step n45). When it is judged in the step n45 that it is not defined, the procedure exits from the loop of n41-n49. When it is judged in the step n45 that it is defined, it is judged whether or not the path replacement target variable X3 is contained in the existing variable pair (step n46). When it is judged in the step n46 that it is contained, the path replacement target variable X3 is eliminated (step n47), and then the procedure is advanced to a step n48. When it is judged in the step n46 that it is not contained, the procedure is advanced to the step n48 without performing the step n47.

In the step n48, the variable to be replaced with the defined path replacement target variable X3 is determined and, thereafter, the defined path replacement target variable X3 is replaced with the determined variable. Then, a pair of the path replacement target variable X3 and the replaced variable is generated anew. After performing the above-described processing, the procedure exits from the loop of n41-n49.

### OPERATION EXAMPLE

Next, referring to FIG. 5, FIG. 9-FIG. 12, a specific example of the operation flow shown in FIG. 2 will be described exemplifying the case of a partial program that is a part of the source program F1 of FIG. 5A. It is assumed here that the intermediate code in this example is expressed with the intermediate code close to the source program F1.

In a step n11, the syntax analysis unit 1 performs the syntax analysis to the partial program in order to generate the partial intermediate code, and stores it in the inside the compiler apparatus A. Then, in the step n12, the program converting section 2A stores the hot path information F2 in the inside the program converting section 2A, upon receiving the input of the hot path information F2 where the path HP, that transits in order of the basic blocks B1, B2, B4, B5, B7 of the control flow graph, is made to be the hot path (see FIG. 5).

In the step n13, the optimizing unit 2 performs the control flow analysis and the dataflow analysis, and the variable information calculating part 2a calculates the existence information IN, the existence information OUT, and the defined information DEF in the basic blocks B1-B7 (FIG. 9A) of the control flow graph (see FIG. 5B). For example, the existence information IN of the basic block B1 (see FIG. 5B) is a variable contained in IN12 of the block B1 in FIG. 9A, and the existence information OUT of the same block is a variable contained in OUT14 of the block B1 in FIG. 9A. Further, the defined information in the same basic block is a variable contained in DEF13 of the basic block B1 in FIG. 9A.

Then, in the step n14, the variable information calculating part 2a calculates the path input variable X1, the path output variable X2, the path replacement target variable X3 and the path guarantee variable X4, based on the existence information and the defined information shown in FIG. 9A, and the hot path information F2 inputted in the step n12 (see FIG. 9B).

The path input variable X1 is a variable that exists at the entrance of the hot path HP, i.e. the existence information IN of the basic block B1 (see FIG. 5B), which is a variable contained in IN12 of the block B1 shown in FIG. 9A. The path output variable X2 is a variable that exists at the exit of the hot path HP, i.e. the existence information OUT of the basic block B7 (see FIG. 5B), which is a variable contained in OUT14 of the block B7 shown in FIG. 9A. The path replacement target variable X3 contains the path input variable X1 and the variables contained in DEF13 (see FIG. 9A) in the basic blocks B1, B2, B4, B5, B7 on the hot path. The path guarantee variable X4 is a variable contained in the path output variable X2 and the path replacement target variable X3.

In this example, the variables contained in DEF13 shown in FIG. 9A are {a, c, d, f, x}, and the path input variables X1 are {b, c, d, e, g, z, w, y}, so that the product set thereof {c, d} becomes the path replacement target variables X3. Further, the path output variables X2 are {a, c, e, f, z, w, x, y}, so that {c} is the path guarantee variable X4. The variable information calculating part 2a sends out the calculated path replacement target variables X3 to the execution path intermediate code generating part 2b, and sends out the calculated path guarantee variable X4 to the guarantee intermediate code generating part 2d.

Then, in the step n15, the execution path intermediate code generating part 2b reads out the partial intermediate code and the hot path information F2, copies the intermediate codes S1-S15 on the hot path HP of FIG. 5, and generates new basic blocks B12-B152 which contain the copied intermediate codes. Then, the variable replacing processing is performed to the path replacement target variables X3 of the copied intermediate codes to generate the variable pairs. FIG. 10 shows the execution path that is generated anew by performing the variable replacing processing to the copied intermediate codes.

Here, operation of the variable replacing processing (FIG. 4) will be described exemplifying the basic blocks B12 and B22 shown in FIG. 10. First, the copied intermediate code contained in the basic block B12 before the variable replacing processing is the same intermediate code as the one contained in the basic block B1 shown in FIG. 5B. In the intermediate code S12 copied in the basic block B12, the path replacement target variable X3 (=c) is referred to (step n42 of FIG. 4: YES). However, there is no pair of variable c. That is, the pair of the variable c is not generated at this point, so that it is judged as NO in the step n43 (the pair is generated in the step n48). Thus, the execution path intermediate code generating part 2b does not perform the variable replacing processing to the variable c of the intermediate code S12.

Further, the path replacement target variable X3 is not defined as “c” in the intermediate code S12 but defined here as “a”, so that it is judged as NO in the step n45. Thus, the variable of the intermediate code S22 to be copied next is now looked at. The execution path intermediate code generating part 2b judges in the intermediate code S22 before replacing the variable that the path replacement target variable X3 (=c) is defined (YES in the step n45), and that there is no pair of the variable c (step N43 of FIG. 4: NO). Based on the judgments described above, the execution path intermediate code generating part 2b replaces the identifier of the variable c at the defined part with t1 that is not used in the variable name table and the variable pair, so as to generate the variable pair (c, t1) anew (step n48).

Then, the execution path intermediate code generating part 2b pays attention to the execution sentence S42 of the next basic block B22 without performing the variable replacing processing, since there is no reference and definition of the path replacement target variable in the intermediate code S32. The generation state of the pair after performing the variable replacing processing to the basic block B12 is as shown in the replacement variable pair generation history 50 of a line of B12 in FIG. 9C.

Subsequently, since the path replacement target variable X3 (=c) is referred to (YES in the step n42) and the pair with the variable c (c, t1) exists in the instruction sentence S42 before replacing the variable, the execution path intermediate code generating part 2b replaces the identifier of the variable c at the referred point with t1. Then, upon judging that the path replacement target variable X3 (=c) is defined in the intermediate code S42 (YES in the step n45) and that the pair with the variable c (c, t1) exists, the execution path intermediate code generating part 2b eliminates the pair with the variable c (c, t1), and then replaces the identifier of the variable c at the defined point with t2 that is not used in the variable name table and the variable pair, so as to generate the variable pair (c, t2) anew (step n48).

In this example, FIG. 9C shows the history 50 of the variable pairs which are generated when the execution path intermediate generating part 2b repeatedly executes the variable replacing processing until the intermediate code S152 of the basic block B72.

The execution path intermediate code generating part 2b sends out the variable pairs (c, t2) and (d, t3) of the block B72 shown in FIG. 9C to the guarantee intermediate code generating part 2d, and sends out the intermediate codes S12-S152 in the execution path intermediate codes shown in FIG. 10 to the judgment intermediate code generating part 2c.

Then, in the step n16, the judgment intermediate code generating part 2c inverts the logic of the judgment conditions of the conditional branching intermediate code S32 (if (t1>0) goto S4 of FIG. 10) and the conditional branching intermediate code S92 (if (f>0) goto S10 of FIG. 10) in the received intermediate codes in order to set the judgment intermediate code of the conditional branching intermediate code S202 (if (t1<=0) goto S1 of FIG. 11) and the conditional branching intermediate code S203 (if (f<=0) goto S1 of FIG. 11) to satisfy the condition where the hot path HP is not executed. The basic block B104 is generated thereby. The judgment intermediate code generating part 2c stores the basic block B104 generated in this manner in the inside of the program converting section 2A.

Subsequently, in the step n17, the guarantee intermediate code generating part 2d generates the code S301 of the guarantee intermediate code whose identifier t2 is returned to the identifier indicating the variable c, based on the path guarantee variable X4 {c} sent out from the variable information calculating part 2a and the variable pair (c, t2), and generates the basic block B103 containing the intermediate code S301 (FIG. 11). Further, the guarantee intermediate code generating part 2d arranges the basic block B103 just after the basic block B104 within the program converting section 2A. The high-speed block H1 is constituted with the basic block B104 and the basic block B103 (H1 of FIG. 11).

Then, in the step n18, the branching intermediate code generating part 2e reads out the basic block B104, and sets the branching intermediate codes of each of the conditional branching intermediate codes S202 and S203 as the branching intermediate codes that branch to the intermediate code S1 of the block B1 as the start point of the partial program. Then the branching intermediate code generating part 2e stores the set branching intermediate codes in the inside of the program converting section 2A.

Further, the branching intermediate code generating part 2e generates the branching intermediate code S151 that branches from the intermediate code S15 of the partial intermediate code to the intermediate code S16, arranges the generated branching intermediate code S151 just after the instruction sentence S15 (see S151 in FIG. 11), and stores it in the inside of the compiler apparatus A. Furthermore, the branching intermediate code generating part 2e arranges the basic block B104 just after the intermediate code S0 as in the program of FIG. 11, and arranges the basic block S103 immediately before the intermediate code S16.

Then, in the step n19, the optimizing unit 2 performs the redundancy eliminating processing to the intermediate program of FIG. 11. The processing of the step n19 is not a central feature of the present invention, so that the explanation thereof is omitted. Explanations hereafter are provided assuming that FIG. 11 itself is the intermediate program after execution of the step.

Then, in the step n20, the intermediate code dependency analyzing part 2f performs the dependency analysis of FIG. 12 to the high-speed block H1 of FIG. 11. The intermediate code dependency analyzing part 2f generates the dependency from the branching conditional intermediate code S202 and the branching conditional intermediate code S203 to the guarantee intermediate code S301 so that the branching conditional intermediate code S202 and the branching conditional intermediate code S203 are executed prior to the guarantee intermediate code S301. Further, in FIG. 12, the intermediate code dependency analyzing part 2f specifies the exception generating intermediate code S102 that induces an exception and the exception generating variable f as a cause for generating the exception (division having 0 as a denominator is not allowed), and generates the dependency from the judgment intermediate code S203 to the exception generating intermediate code S102 so that the judgment intermediate code S203 corresponding to the exception generating variable f is executed prior to the exception generating intermediate code S102.

Now, a case of generating an exception will be described. If the intermediate code S102 is executed prior to the judgment intermediate code S203 and the value of the variable f is zero, zero-division is generated in the intermediate code S102. Thus, an exception is generated in the processor or the operating system. Examples of the exceptions other than that are as follows. That is, it is assumed now that there is a state where the variable f is the pointer variable in C-language, and an indirect reference of the variable f occurs by the intermediate code S102. At this time, similarly, if the intermediate code S102 is executed prior to the judgment intermediate code S203, and the variable f holds the unloaded addresses or an address of a memory to which an access is inhibited, an exception is also generated in the processor or the operating system.

In the next step n21, as shown in FIG. 13, the intermediate code parallelizing part 2g performs scheduling to parallelize the intermediate code strings from the dependency analysis information (see FIG. 12) that is sent out from the intermediate code dependency analyzing part 2f. FIG. 13 shows a program to which the list scheduling method is applied, by giving priority to the depth of the dependencies shown in FIG. 12. A notation “//” indicates that the instruction sentences following this are executed in parallel.

### Modification Example 1

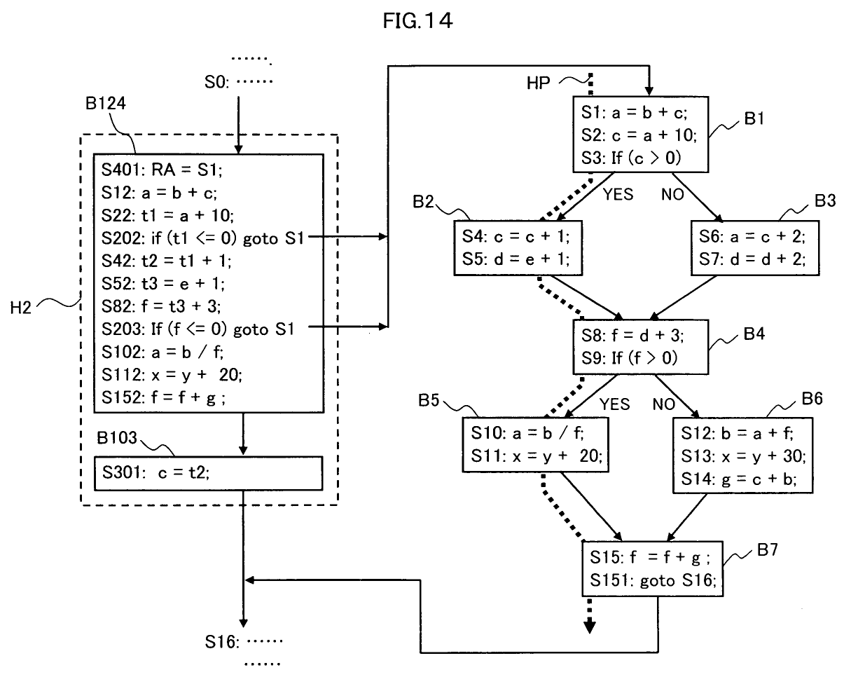

### Acceptable Generation of Exception: See FIG. 14-FIG. 17

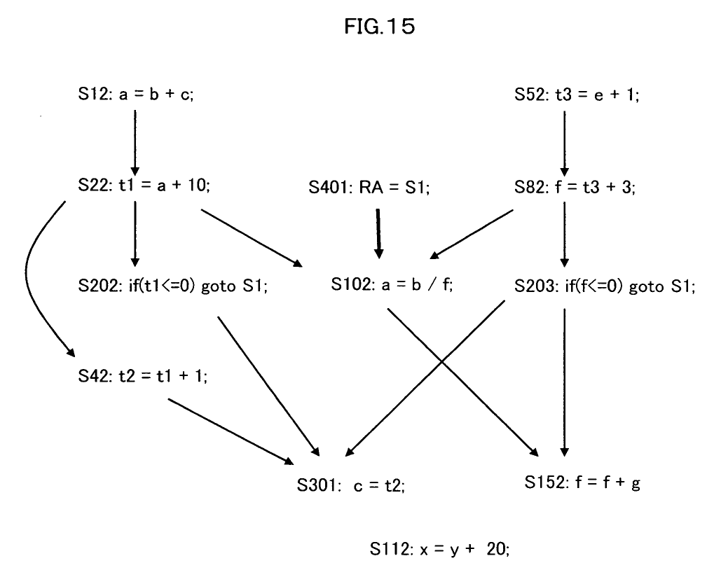

In the above-described embodiment, the intermediate code dependency analyzing part 2f generates dependency from the judgment intermediate code S203 to the exception generating intermediate code S102 in FIG. 12, so that an exception is not generated improperly. In Modification Example 1, however, such dependency is not generated. That is, the execution path intermediate code generating part 2b generates an intermediate code S401 anew as shown in a program of FIG. 14, and thereafter generates dependency from the intermediate code S401 to the exception generating intermediate code S102 as shown in a program of FIG. 15.

That is, the execution path intermediate code generating part 2b inserts the variable and the code to the head of the execution path intermediate code string which are generated as below.
Generate a return point holding variable that is a special variable for holding the returning address in returning from an interruption routine.
Generate a return-use intermediate code that is an intermediate code for storing the returning address in the return point holding variable (return point setting instruction code generator).

Further, the intermediate code dependency analyzing part 2f operates so that dependency is not generated between the judgment intermediate code related to the above-described exception generating variable and the exception generating intermediate code, and then generates the dependency from the return-use intermediate code to the exception generating intermediate code (second dependency analyzer).

Hereinafter, the above-described processing will be described more specifically referring to FIG. 14-FIG. 17. First, in the step n15, the execution path intermediate code generating part 2b generates the return point holding variable RA as shown in the intermediate code S401 of FIG. 14, and inserts the return-use intermediate code S401 for storing the returning point address S1 to the variable RA into the head of the execution path intermediate code string.

Then, in the step n20, the intermediate code dependency analyzing part 2f generates the dependency form the return-use intermediate code S401 to the exception generating intermediate code S102. At this time, as shown in FIG. 15, the intermediate code dependency analyzing part 2f does not generate dependency between the judgment intermediate code S203 related to the above-described exception generating variable and the exception generating intermediate code S102.

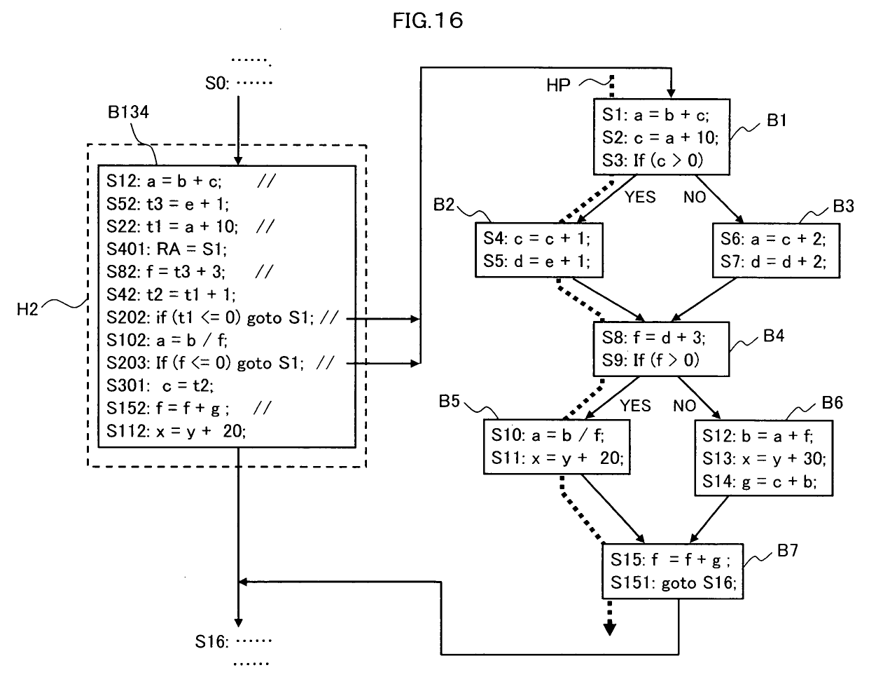

FIG. 16 shows the result obtained when the intermediate code parallelizing part 2g performed scheduling by utilizing the dependency analysis information shown in FIG. 15. In the drawings, it is scheduled so that the exception generating intermediate code S102 is executed prior to the judgment intermediate code S203.

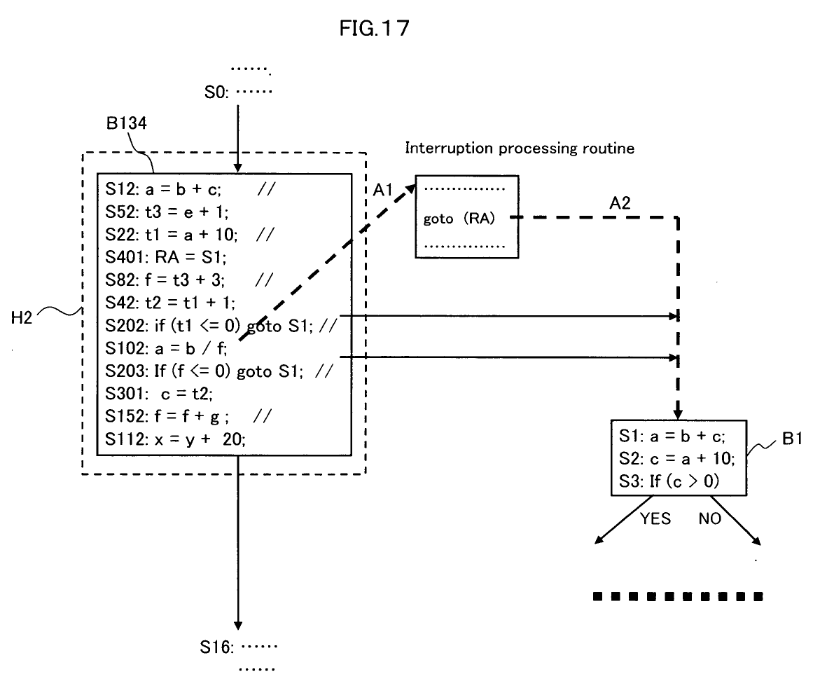

FIG. 17 is a diagram showing the executing operation on the system when an exception is generated in the exception generating intermediate code S102. First, in addition to a series of the interruption processing, the type of interruption is judged. Then, the interruption routine to be branched to the address held in the return point holding variable is prepared in advance in a computer system (processing routine adder used when interruption is generated). Then, when an exception is generated in the exception generating intermediate code S102, the control is transited to the interruption processing routine by the processor or the operating system (see a broken line A1 of FIG. 17), and the processing is branched from the interruption processing routine to the address S1 that is held in the return point holding variable RA (see a broken line A2 of FIG. 17). The return point holding variable is allocated to the storage element such as a specific memory or a specific register by the resource allocation unit 3.

In the case of the above-described high-speed block H2 shown in FIG. 16, there is no change in terms of the number of execution steps compared to the high-speed block H1 of FIG. 13, and there is no specific improvement observed in the performance. However, in general, an obstruction may be generated in achieving much faster execution in the high-speed block H1 under the following conditions.
The provability of generating an exception is low.
Dependency is generated from the judgment intermediate code S203 that is generated from the program or the like of FIG. 12 to the exception generating intermediate code S102.

In response to such inconvenience, the dependency itself that may become the obstacle to the high-speed execution can be cancelled in this modification example. Therefore, it is possible to achieve much faster execution of the high-speed block.

### Modification Example 2

### Constant Value Propagation Modification 1

In the above-described embodiment, as the hot path information F2 (see FIG. 1), the user may input the variable holding information that is the information of the values held by the variables referred to in the hot path HP, in addition to the information showing the execution path that is determined by the user in advance. The values of the variable in the variable holding information is the values that are highly possible to be held by the variable.

By utilizing the variable holding information within the hot path information F2, the branching intermediate code generating part 2e replaces the reference point of the variable within a high-speed block H3 with a value held by the variable holding information. Further, when the value held by the variable becomes different form the value kept up in the variable holding information, the branching intermediate code generating part 2e may generate the conditional branching intermediate code (referred to as a constant value judging condition branching intermediate code) at the head of the execution path intermediate code string to be started from the start point of the partial intermediate code (second execution path code generator).

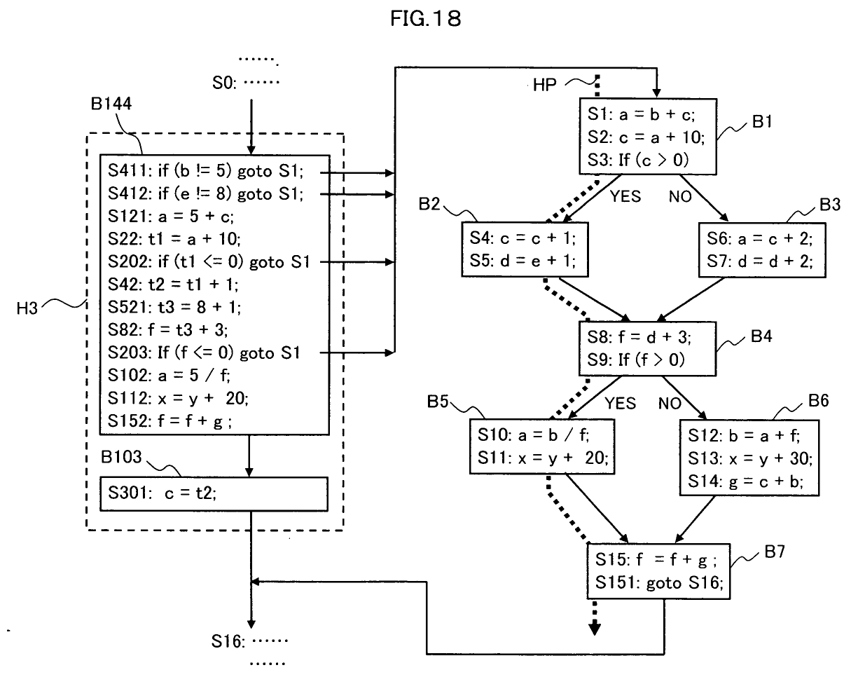

Hereinafter, the processing in the above-described case will be described referring to FIG. 18-FIG. 20. FIG. 18 shows the result of the processing performed by the branching intermediate code generating part 2e when the value of the variable b in the variable holding information within the hot path information F2 is “5”, and the value of the variable e is “8”. In FIG. 18, the reference points of the variable b and the variable e are replaced with the value “5” and the value “8”, respectively. Further, a constant value judging condition branching intermediate code S411 is generated at the head of the execution path intermediate code string, which branches to the intermediate code S1 when the value held by the variable is not “5”. Similarly, a constant value judging condition branching intermediate code S412 is generated corresponding to the variable e.

In the step n18, the branching intermediate code generating part 2e retrieves the variable holding information within the hot path information F2, and replaces the reference point of the variable of the high-speed block H3 with a value held in the variable holding information.

FIG. 18 shows the state where the value of the variable b within the variable holding information becomes “5” and the value of the variable e becomes “8”. As can be seen from a comparison with FIG. 11, the reference points of the variable b and the variable e are replaced with the value “5” and the value “8”, respectively. Further, the branching intermediate code generating part 2e generates the conditional branching intermediate code to execute from the 0start point of the partial intermediate code, when the value held by the variable is different from the replaced value. In FIG. 18, when the value held by the variable b is not “5”, the branching intermediate code generating part 2e first generates the constant value judging condition branching intermediate code S411 at the head of the execution path intermediate code string, which branches to the intermediate code S1. Similarly, the branching intermediate code generating part 2e generates the constant value judging condition branching intermediate code S412 corresponding to the variable e.

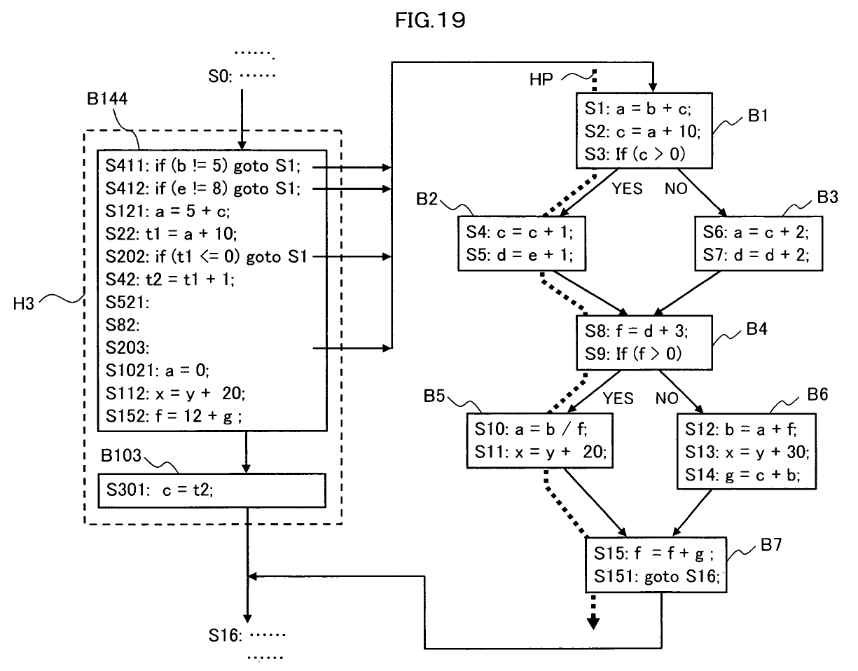

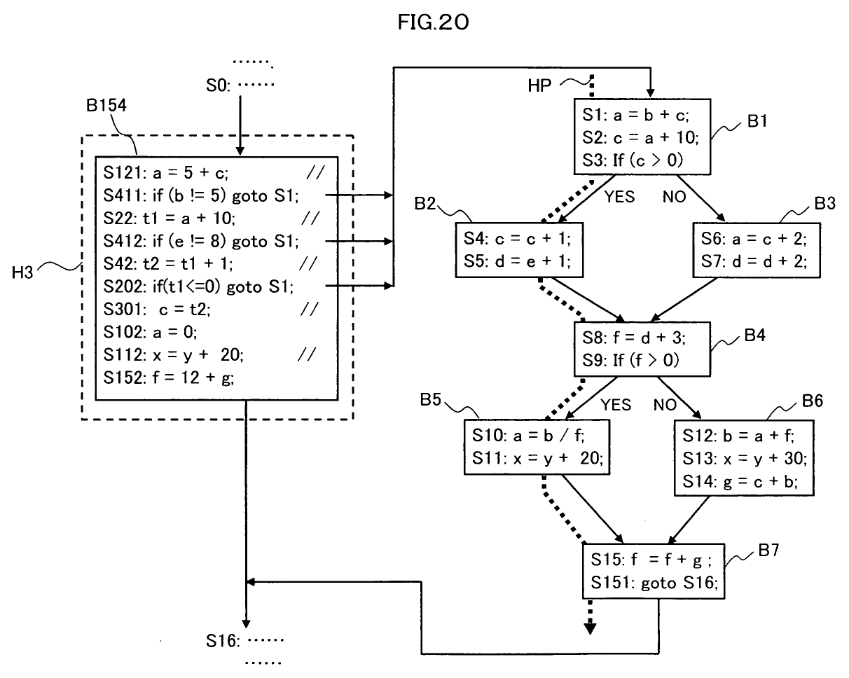

In the next step n19, the optimizing unit 2 performs the redundancy eliminating processing to the intermediate program of FIG. 18. FIG. 19 shows the result obtained by performing the redundancy eliminating processing. By the effect of the constant value propagation optimization, the intermediate code S521 and the intermediate code S82 are eliminated, and the judgment intermediate code S203 is eliminated by the unnecessary code eliminating optimization. FIG. 20 shows the result obtained by performing the step n20 and step n21. The number of steps is reduced by one step compared to the case of FIG. 13.

As described above, among the variables referred to in the hot path HP, when the values held by the variables are localized to a specific value, it is possible to improve the speed of the high-speed block further.

### Modification Example 3

### Constant Value Propagation Modification 2

In Modification Example 2 described above, the branching intermediate code generating part 2e has performed the constant value replacing processing and generating processing of the constant value judging condition branching intermediate code to the high-speed block H1. However, the branching intermediate code generating part 2e may first copy the high-speed block H1, and then perform the constant value replacing processing and generating processing of the constant value judging condition branching intermediate code to the high-speed block H1. Further, the branching intermediate code generating part 2e may generate a dummy intermediate code constituted only with a label just before the start point of the high-speed block H1 before being copied, and the branching destination of the constant value judging condition branching intermediate code may be set to the dummy intermediate code. Furthermore, a branching intermediate code that branches to the intermediate code just after the end pint of the partial intermediate code may be inserted to the position just after the end point of the high-speed block H1 before being copied.

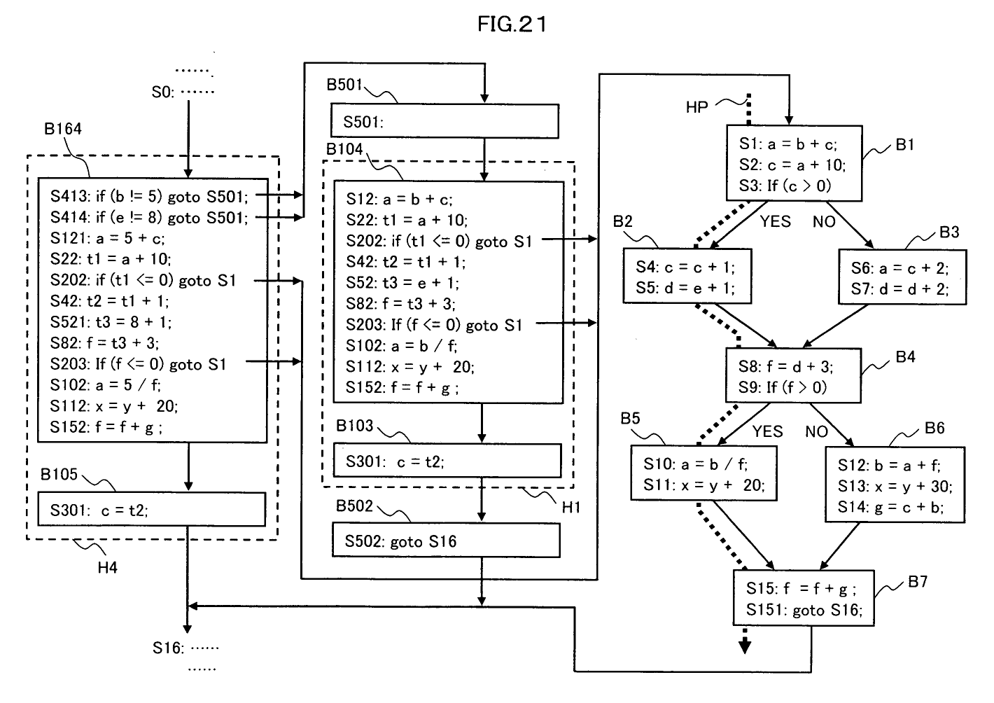

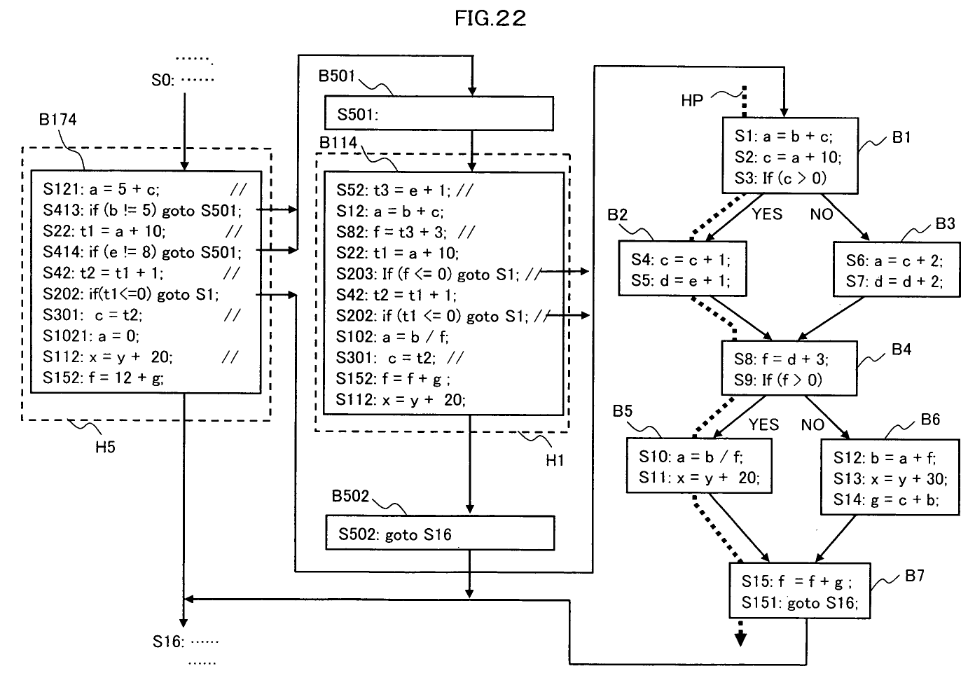

Hereinafter, the processing of the above-described case will be described referring to FIG. 21-FIG. 22. In the step n18, the branching intermediate code generating part 2e copies the high-speed block H1, and performs the replacing processing for replacing the variable in the copied high-speed block H1 with a constant value. In the copied high-speed block H4 of FIG. 21, the reference points of the variable b and the variable e are changed to a constant value “5” and a constant value “8”, respectively.

Furthermore, the branching intermediate code generating part 2e generates a dummy intermediate code constituted only with a label before the high-speed block H1 before being copied, and generates the branching intermediate code that branches to the intermediate code just after the end pint of the partial intermediate code immediately after the end point of the high-speed block H1 before being copied. In FIG. 21, the intermediate code S501 is the intermediate code only with a label, and the branching intermediate code S502 is the intermediate code that branches to the intermediate code S16 that is the intermediate code just after the end point of the partial intermediate code (second branching code generator)

Further, the branching intermediate code generating part 2e sets the branching destination of the constant value judging condition branching intermediate code in the copied high-speed block H1 to the generated dummy intermediate code (third execution path code generator). In FIG. 21, the branching destination of the constant value judging condition branching intermediate code S413 is set to the intermediate code S501 and, similarly, the branching destination of the constant value judging condition branching intermediate code S414 is set to the intermediate code S501. FIG. 22 shows the result obtained by performing the step n19, the step n20, and the step n21. Even in the case where the value held by the variable is different from the value held in the hot path information F2, execution control can be transited to another high-speed block whose speed is improved compared to the partial intermediate code through the program conversion performed in the manner described above. Thus, high-speed execution of the hot path HP can be accelerated.

### Modification Example 4

### Branching to the Point in the Middle of Partial Intermediate Code String

In <Operation Example> described above, the branching intermediate code is set to branch from the high-speed block H1 to the intermediate code S1 that is the start point of the partial intermediate code string, as shown in the conditional branching intermediate codes S202 and S203 of FIG. 11. However, the execution procedure of the partial program may be shortened or the partial intermediate code string may be reduced by omitting a part of execution of the partial intermediate code string through constituting the high-speed block to branch to the point in the middle of the partial intermediate code string.

Further, conversion may also be applied to the partial intermediate code string so that the intermediate codes in the high-speed block, which correspond to the intermediate codes within the basic blocks (for example, the basic block B1, the basic block B4, and the basic block B7 in the case of FIG. 11) whose controls interflow within the partial intermediate code string, can move over (crossing) the conditional branching intermediate codes. Hereinafter, this conversion will be described in more details.

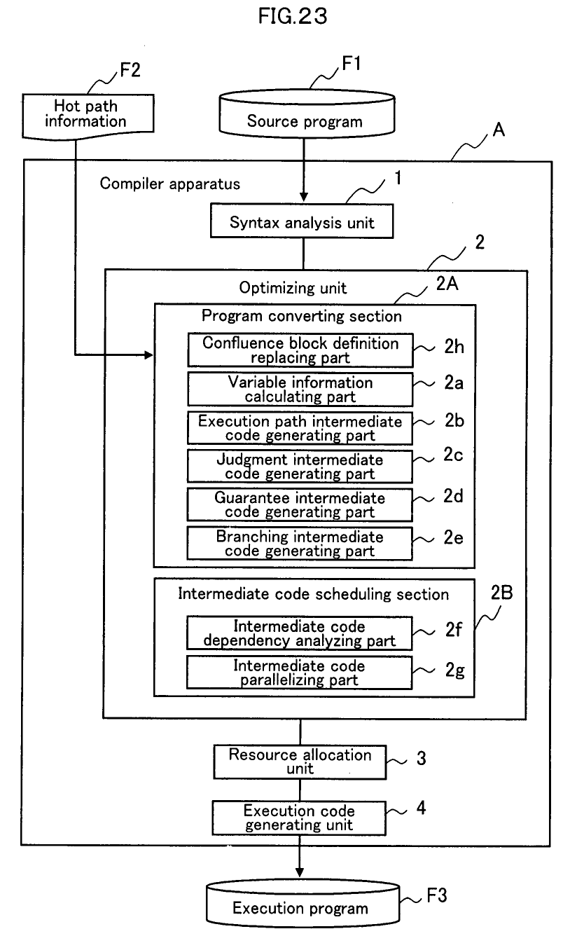

As shown in FIG. 23, a confluence block definition replacing part 2h is added to the whole structure of the compiler apparatus A shown in FIG. 1. The confluence block definition replacing part 2h first calculates the confluence blocks that are the basic blocks whose controls interflow on the hot path HP. More exactly, the basic blocks that are inevitably contained in the entire optical path from the start point to the end point of the hot path HP become the confluence blocks (the basic block containing the start point and the end point is also a confluence block).

Next, when there is a variable defined by the confluence block, the following processing is performed to the identifiers at the defined points and reference points of the variables that are present in the entire path from the defined point of the variable defined in the confluence block to the exit of the hot path HP. That is, by referring to the variable name list that shows the identifiers and the like of the variables, the identifiers of the variables are replaced with the identifiers that are not present in the variable name list. However, if there is a plurality of periods where the value held by the variable exists, the identifiers of the variables at the defined point and the reference point of the variable in the existing period are replaced with the identifiers that are not in the variable name list by each of the existing periods (confluence definition variable replacing device).

Furthermore, when the variable defined by the confluence block exists at the entrance of the hot path HP, an intermediate code string which restores the identifier of the variable defined by the confluence block to the original identifier is generated at the end point of the hot path HP (confluence definition variable guarantee code generator).

The confluence block definition replacing part 2h changes the dataflow information of the identifier that has been changed. In changing the dataflow information, the dataflow information concerning all the variables may be updated again.

Further, the branching intermediate code generating part 2e shown in FIG. 23 may perform the following processing. That is, the branching intermediate code generating part 2e reads out the conditional branching intermediate codes contained in the execution path intermediate code string in the program converting section 2A and the conditional branching intermediate codes in the partial intermediate code string in order pair by pair. Further, the branching intermediate code generating part 2e extracts the intermediate code to which control is transited and is not present on the hot path HP from the readout conditional branching intermediate codes. Then, the branching intermediate code generating part 2e sets the branching intermediate code of the conditional branching intermediate code as the intermediate code that is not present on the hot path. Herewith, it can be branched to the intermediate code in the middle of the partial intermediate code string that is supposed to be executed originally, when the condition of the conditional branching intermediate code contained in the execution path intermediate code string is approved.

Further, the intermediate code dependency analyzing part 2f shown in FIG. 23 may perform the following processing. That is, the intermediate code dependency analyzing part 2f extracts the conditional branching intermediate code that is found first from the intermediate code towards the end point of the high-speed block, from the intermediate code (except for the conditional branching intermediate code) generated from the confluence block among the intermediate codes of the high-speed block. Further, the intermediate code dependency analyzing part 2f generates the dependency from the intermediate code generated in the confluence block to the extracted conditional branching intermediate code. Herewith, the following advantages can be obtained.

It is probable that the intermediate code parallelizing part 2g performs the scheduling to the intermediate codes generated from the confluence block over the conditional branching intermediate code that is found towards the start point of the high-speed block. However, by performing the above-described control, it becomes impossible to perform the scheduling by going over the conditional branching intermediate code that is found first towards the end point of the high-speed block.

Further, the intermediate code dependency analyzing part 2f shown in FIG. 23 may perform the following processing. That is, the intermediate code dependency analyzing part 2f extracts the conditional branching intermediate code that is found first from the intermediate code towards the start point of the high-speed block, from the intermediate codes generated from the basic block that is not the confluence block among the intermediate codes of the high-speed block. Further, the intermediate code dependency analyzing part 2f generates the dependency from the extracted conditional intermediate code to the intermediate code generated from the basic block that is not the confluence block.

Furthermore, the intermediate code dependency analyzing part 2f shown in FIG. 23 may perform the following processing. That is, the intermediate code dependency analyzing part 2f extracts the conditional branching intermediate code that is found first from the intermediate code towards the end point of the high-speed block, from the intermediate codes generated from the basic block that is not the confluence block among the intermediate codes of the high-speed block. Further, the intermediate code dependency analyzing part 2f generates the dependency from the intermediate code generated from the basic block that is not the confluence block to the extracted conditional branching intermediate code. Herewith, the intermediate code parallelizing part 2g cannot perform the scheduling through going over the intermediate codes and the conditional branching intermediate codes generated from the basic blocks that are not the joining block.

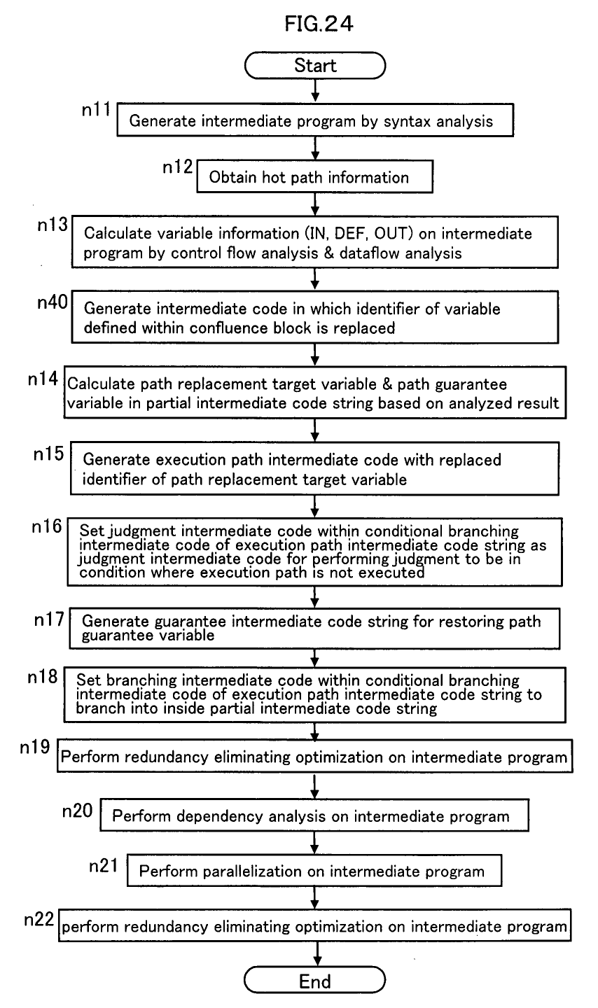

The operation flow shown in FIG. 2 is modified in accordance with the above-described improvement of the control. That is, as shown in FIG. 24, a step n40 is added to the operation flow of FIG. 2 for generating the intermediate code whose identifier of the variable defined within the confluence block is replaced. Further, the step n18 is changed so that the branching intermediate code in the conditional branching intermediate code of the execution path intermediate code string is branched in the middle of the partial intermediate code. Furthermore, the step n20 is changed to generate the dependency between the intermediate codes in the high-speed block H4, so that only the intermediate codes generated from the confluence block become the targets of the scheduling performed over the conditional branching intermediate codes. Moreover, a step n22 for performing the redundancy eliminating processing again on the intermediate program is added after the parallelization of the intermediate program.

Herewith, through generating the dependency between the intermediate codes generated from the confluence block and the intermediate codes generated from the basic block that is not the confluence block, and the conditional branching intermediate code, the equivalency of the program before and after conversion can be guaranteed in the program conversion where branching is performed to the middle of the partial intermediate code string.

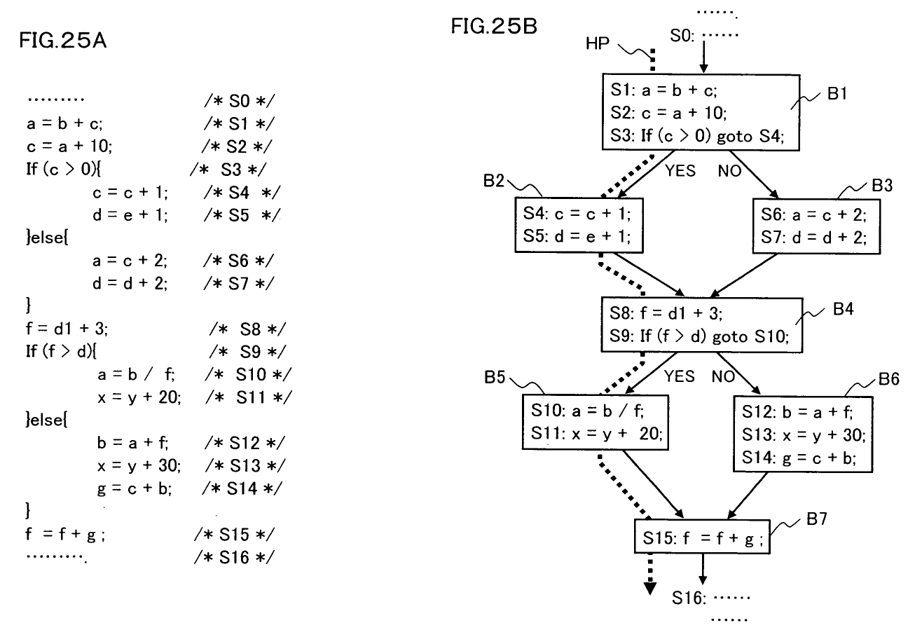

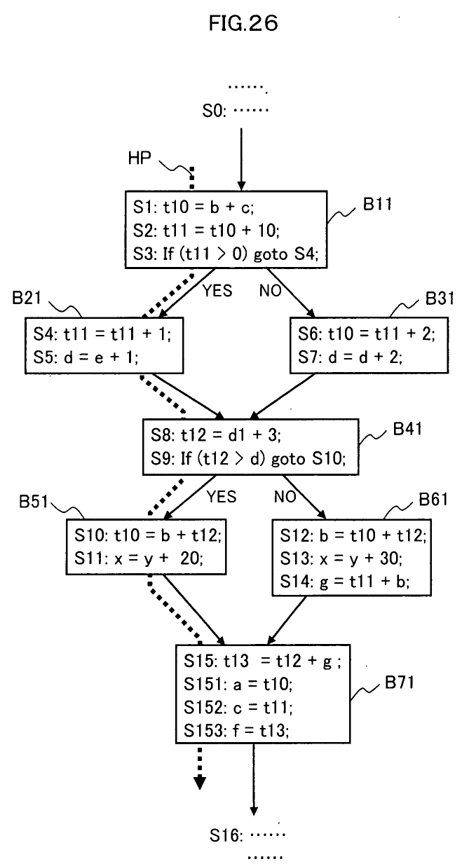

FIG. 25A and FIG. 25B show an example of the source program F1 obtained by partially changing the source program F1 of FIG. 5A and FIG. 5B. The intermediate code S8 and the intermediate code S9 are changed from those of the program structure shown in FIG. 5A and FIG. 5B. Hereinafter, the main step in FIG. 24 will be described referring to FIG. 26-FIG. 32.

In step n40, the program of FIG. 25A and FIG. 25B is updated as shown in FIG. 26. That is, in FIG. 25A and FIG. 25B, the variable a is defined with the intermediate code S1 of the confluence block B1. The values held in the variables a in the intermediate code S1, the intermediate code S6 that is a definition of the variable a, are referred to with the intermediate code S12. Further, since the variable a also exists at the exit of the basic block B7, the value held in the variable a is also referred to after the basic block 7. Furthermore, the value held in the variable a in the intermediate code S10 that is the definition of the variable a is also referred to after the basic block 7, since the variable a also exists at the exit of the basic block B7.

Thus, each of the following periods constitutes the same existing period of the variable a.
A period from the intermediate code S1 leading up to the exit of the basic block B7 through the basic block B2, the basic block B4, and the basic block B6.
A period from the intermediate code S6 leading up to the exit of the basic block B7 through the basic block B4 and the basic block B6.
A period from the intermediate code S10 leading up to the exit of the basic block B7.

Therefore, the confluence block definition replacing part 2h replaces the defined point and the reference point (both exist in the existing period of the variable a) of the variable a with the identifier t10 that is generated anew. Furthermore, the confluence block definition replacing part 2h generates an intermediate code S151 for restoring the identifier t10 to the identifier a at the end point of the hot path HP.

Similarly, in the variable f, the period from the intermediate code S8 leading up to the entrance of the basic block B7 and the period from the intermediate code S15 at least leading up to the exit of the basic block B7 are the existing periods of the variables f having a different value from each other.

Thus, the confluence block definition replacing part 2h performs the following processing.
Replace the defined point and the reference point of the variable f that is present in the existing period from the intermediate code S8 leading up to the entrance of the basic block B7 with an identifier t12 that is generated anew.
Replace the defined point that is present in the existing period from the intermediate code S15 up to the exit of the basic block B7 with an identifier t13 that is generated anew.

Further, the confluence block defining replacing part 2h performs the processing to generate an intermediate code S153 for restoring the identifier t13 to the identifier f at the end point of the hot path HP.

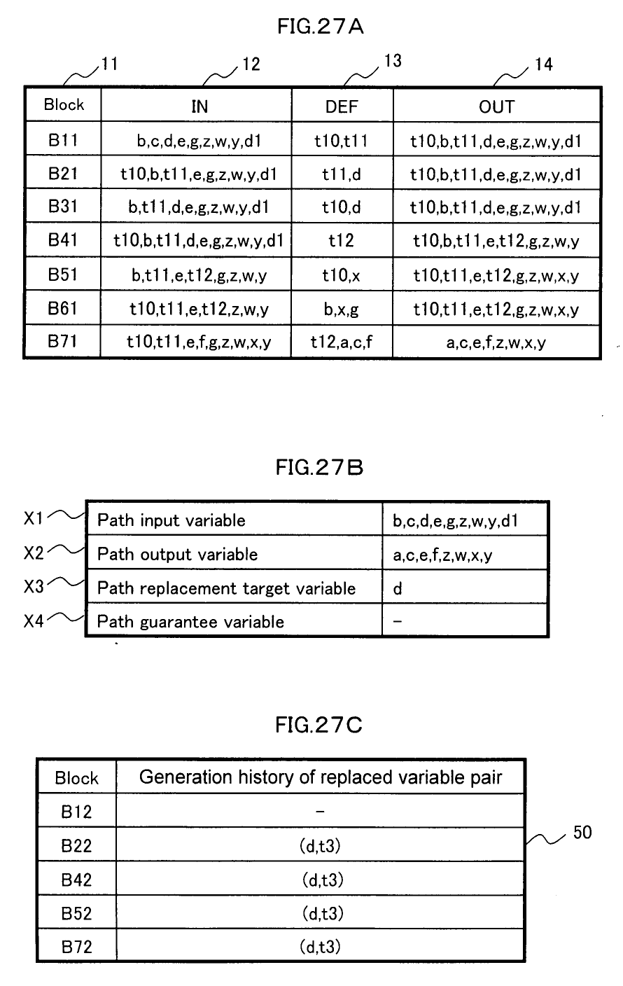

Furthermore, the confluence block defining replacing part 2h replaces the variable c also in the same manner. Moreover, the confluence block defining replacing part 2h changes the dataflow information of the identifiers that have been changed as shown in FIG. 27A.

In the step n14, as shown in FIG. 27B, the path input variable X1, the path output variable X2, the path replacement target variable X3 and the path guarantee variable X4 are calculated from the intermediate program of FIG. 26. However, there is no path guarantee variable X4 in this example.

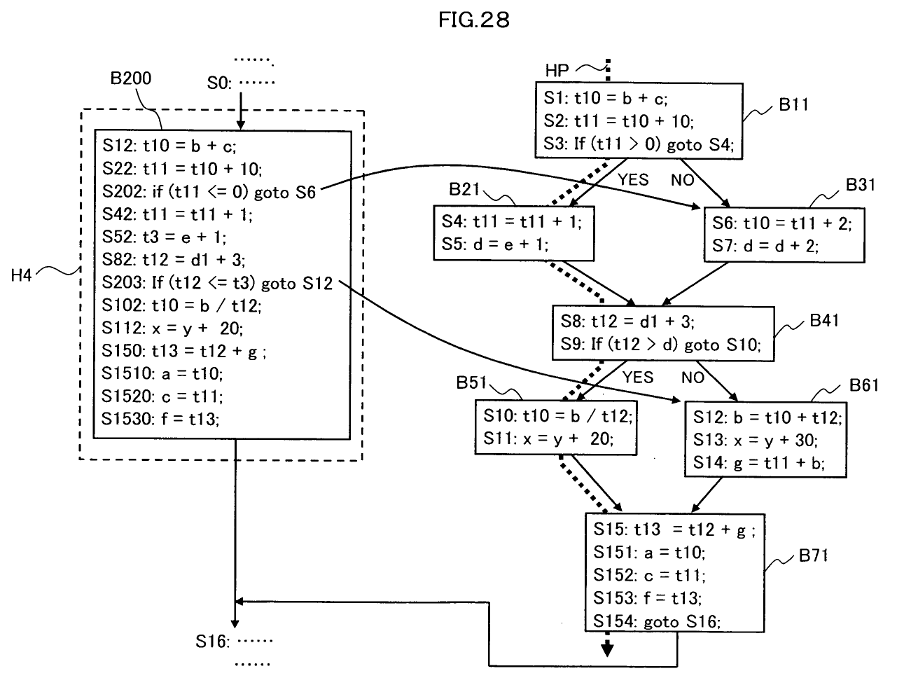

In the step n15, identifier replacing processing is performed to the intermediate code S52, the intermediate code S203 of FIG. 28 and the path replacement target variable X3 (=d) shown in FIG. 27C so as to generate an execution path intermediate code string B200 that is shown in FIG. 28.

In the step n16, as shown in the conditional branching intermediate code S202 and the conditional branching intermediate code S203 of FIG. 28, the conditional branching intermediate codes, wherein the condition of the judgment intermediate code is logic-inverted in the conditional branching intermediate code S3 and the conditional branching intermediate code S9 of FIG. 26, are set.

In the step n18, the branching destination of the conditional branching intermediate code S202 and the conditional branching intermediate code S203 of FIG. 28 is set at the position to be branched in the middle of the partial intermediate code string. That is, the branching intermediate code of the conditional branching intermediate code S202 is set as the intermediate code S6, and the branching intermediate code of the conditional branching intermediate code S203 is set as the intermediate code S12.

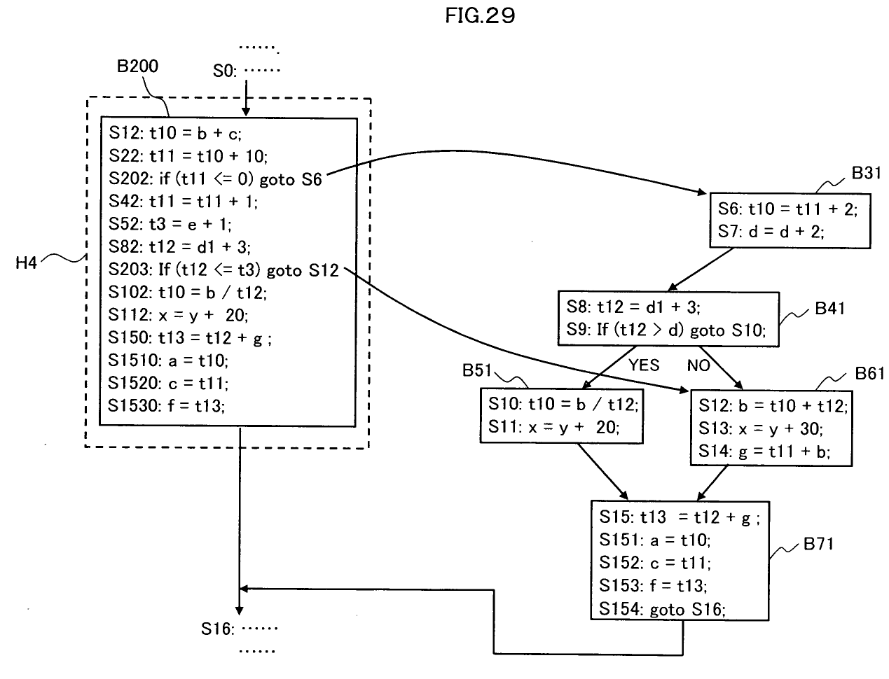

In the step n19, the redundancy elimination optimizing processing is performed to the intermediate program of FIG. 28. In FIG. 28, since there is no path that reaches to the basic block B11 and the basic block B21, a part of the program is eliminated as shown in FIG. 29.

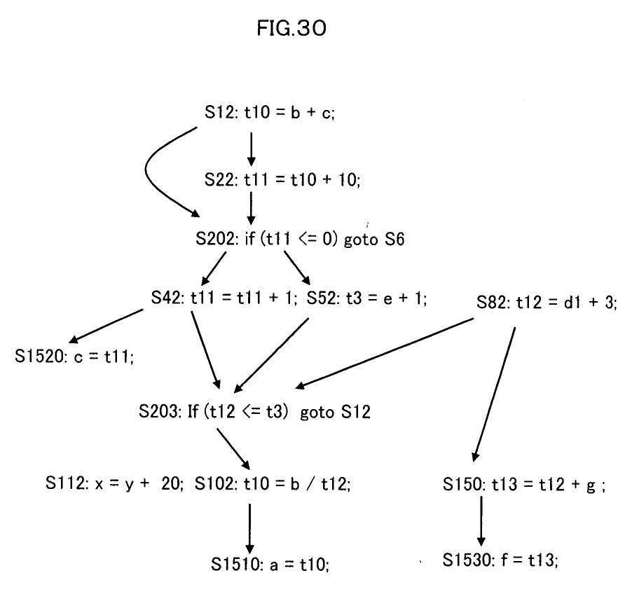

In the step n20, the dependency analysis of the high-speed block H4 is performed. At that time, in addition to the dependency analysis (dependency generation) of the regular data, the dependency analysis (dependency generation) is performed so that the scheduling is not performed by going over the conditional branching intermediate code that is found in the end-point direction of the high-seed block in the intermediate codes generated from the confluence block. For example, as shown in FIG. 30, the intermediate code S12, the intermediate code S22 and the intermediate code S82 are the intermediate codes generated from the confluence block. Thus, the following dependency is generated, respectively.
Dependency from the intermediate code S12 to the conditional branching intermediate code S202
Dependency from the intermediate code S22 to the conditional branching intermediate code S202
Dependency from the intermediate code S82 to the conditional branching intermediate code S203

The data dependency concerning the variable t11 also exists in from the intermediate code S22 to the conditional branching intermediate code S202. Further, the data dependency concerning the variable t12 also exists in from the intermediate code S82 to the conditional branching intermediate code S203.

Furthermore, dependency is generated in the intermediate codes generated from the basic block that is not the confluence block, so that scheduling is not performed by going over the conditional branching intermediate code. For example, as shown in FIG. 30, the intermediate code S42 and the intermediate code S52 are the intermediate codes generated from the basic block that is not the confluence block. Thus, the followings are generated, respectively.
Dependency from the conditional intermediate code S202 to the intermediate code S42
Dependency from the conditional branching intermediate code S202 to the intermediate code S52
Dependency from the intermediate code S42 to the conditional branching intermediate code S203
Dependency from the intermediate code S52 to the conditional branching intermediate code S203

The data dependency concerning the variable t3 also exists in from the intermediate code S52 to the conditional branching intermediate code S203.

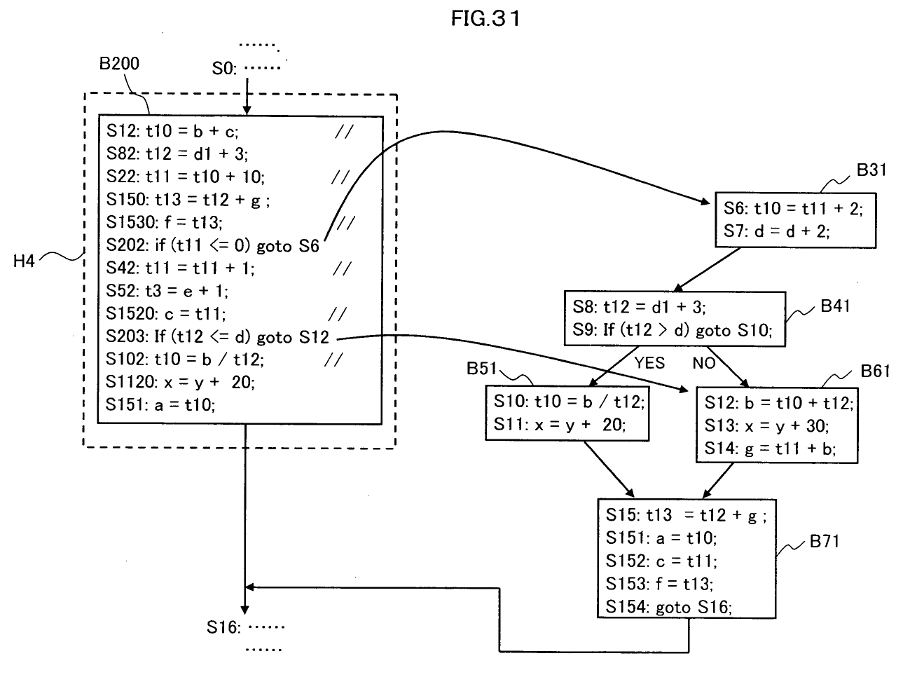

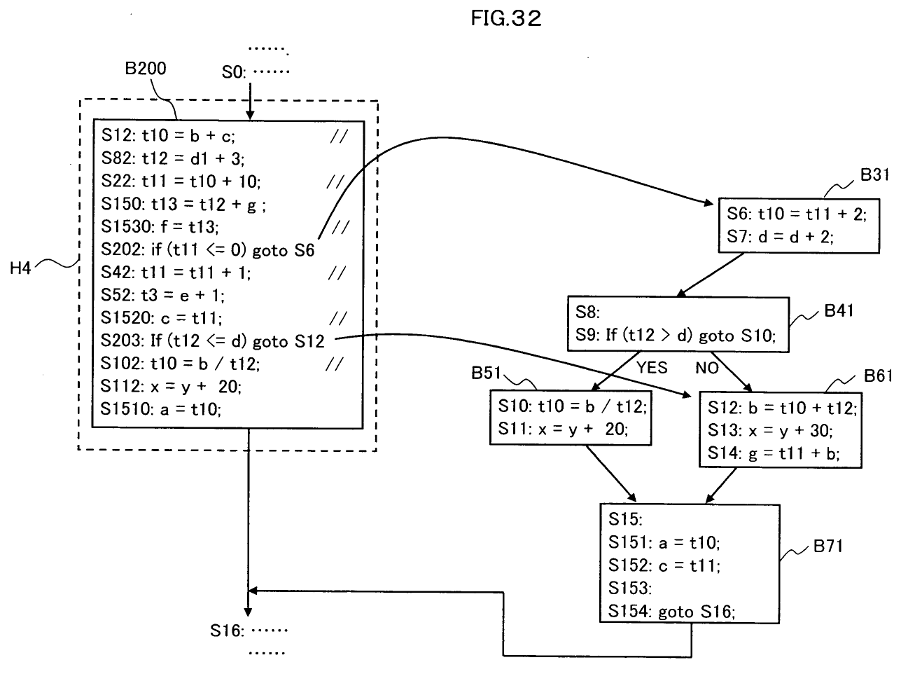

In the step n21, the intermediate code string is scheduled in the parallelized block H4 as shown in FIG. 31 in accordance with the dependency shown in FIG. 30. In the step n22, further, the redundancy eliminating optimization is performed to the intermediate program of FIG. 31. Here, the intermediate code S8, the intermediate code S15 and the intermediate code S153 are eliminated as shown in FIG. 32, through the optimizing processing using equivalent expression set that is exemplified in Patent Literature 1 described above. For example, there is no intermediate code for updating the variable d1 or the intermediate code for updating the variable t12 on the path from the intermediate code S82 up to the intermediate code S8 of FIG. 31. Thus, the intermediate code S8 is judged as redundant calculation, so that it is eliminated. Further, the intermediate code S15 and the intermediate code S153 of FIG. 31 are judged as more redundant calculations than the intermediate code S150 and the intermediate code S1530, so that those are eliminated.

### Modification Example 5

### Probability

In the above-described embodiment, the optimizing unit 2 may control a way of conversion based on the probability of approval or no approval to the judgment condition of the conditional branching intermediate code on the hot path HP, the probability of generating an exception and the probability of a specific variable holding a specific value. The probabilities themselves can be obtained from the hot path information F2.

For example, in the program of FIG. 5A and FIG. 5B, it is assumed that the probability of approving the judgment of the conditional branching intermediate code S3 is p1, and the probability of approving the judgment of the conditional branching intermediate code S9 is p2. Accordingly, the probability of executing the hot path HP is the multiplication value of the probability p1 and the probability p2, i.e. p1*p2. When a certain specific threshold value T1 is set to a proper value, and the multiplication value p1*p2 is larger than the threshold value T1, the program shown in FIG. 5A and FIG. 5B is converted to a program shown in FIG. 13 (first execution path conversion judging device).

Further, when the probability of generating an exception in the exception generating intermediate code S10 shown in FIG. 5A and FIG. 5B is p3, if the probability p3 is larger than T2 when a certain specific threshold value T2 is set as a proper value, the program shown in FIG. 5A and FIG. 5B is converted to the program shown in FIG. 13. If it is smaller, the program shown in FIG. 5A and FIG. 5B is converted to a program shown in FIG. 16 (third execution path conversion judging device).

Furthermore, it is assumed that the probabilities for each of the variables b and e to have the values “5” and “8” at the entrance of the basic block B1 shown in FIG. 5A and FIG. 5B are p4 and p5, respectively. As a result that a certain specific threshold value is set as a proper value, when the value of the multiplication p1*p2*p4*p5 is larger than the threshold value T3, the program shown in FIG. 5A and FIG. 5B is converted to a program shown in FIG. 20 (fifth execution path conversion judging device).

The threshold value T1, the threshold value T2, and the threshold value T3 may be obtained from the hot path information F2 or those may be the values held by the optimizing unit 2.

### Modification Example 6

### Average Execution Time

In the above-described embodiment, the optimizing unit 2 may determine the intermediate code to be outputted at last by using the average of the execution time. For example, in FIG. 5A and FIG. 5B, provided that the probability for the conditional branching intermediate code S3 to become true is p1, and that the probability for the conditional branching intermediate code S9 to become true is p2, those probabilities can be obtained from the hot path information F2.

Further, in the program shown in FIGS. 5A and 5B, it is assumed as follows.
The execution time for sequentially executing the basic block B1, the basic block B2, the basic block B4, the basic block B5 and the basic block B7 is T51.
The execution time for sequentially executing the basic block B1, the basic block B2, the basic block B4, the basic block B6 and the basic block B7 is T52.
The execution time for sequentially executing the basic block B1, the basic block B3, the basic block B4, the basic block B5 and the basic block B7 is T53.
The execution time for sequentially executing the basic block B1, the basic block B3, the basic block B4, the basic block B6 and the basic block B7 is T54.

In this case, the average execution time of the program shown in FIG. 5A and FIG. 5B is expressed as follows.

ET1=T51*p1*p2+T52*p1*(1−p2)+T53*(1−p1)*p2+T54*(1−p1)*(1−p2) (Expression 1)

Further, it is assumed as follows.
The execution time from the intermediate code S52 leading up to the intermediate code S112 in FIG. 13 is T131.
The execution time from the intermediate code S52 leading up to the intermediate code S203 is T132.
The execution time from the intermediate code S52 leading up to the intermediate code S202 is T133.

In this case, the average execution time of the program shown in FIG. 13 is expressed as follows.

ET2=T131*p1*p2+T132*(1−p2)+T52*p1*(1−p2)+T54*(1−p1)*(1−p2)+T133*(1−p1)*p2+T53*(1−p1)*p2+T54*(1−p1)*(1−p2) (Expression 2)

At this time, when it is judged that the average execution time ET2 is smaller than the average execution time ET1, the processing for converting the program of the FIG. 5A, FIG. 5B to the program shown in FIG. 13 is performed (second execution path conversion judging device). Similarly, in the processing to convert the program into the programs shown in FIG. 16, FIG. 20, FIG. 22, and FIG. 32, it is possible to calculate the average execution time and then select the conversion to the program having the small average execution time.

In the program shown in FIG. 16, it is assumed as follows.
The execution time from the intermediate code S12 up until the intermediate code S112 is T161.
The execution time from the intermediate code S12 up until the intermediate code S202 is T162.
The execution time from the intermediate code S12 up until the intermediate code S203 is T163.
The probability of generating an exception in the intermediate code S10 shown in FIG. 5A and FIG. 5B is p3.

In this case, the average execution time of the program shown in FIG. 16 is expressed as follows.

ET3={T161*p1*p2+T162*(1−p1)*p2+T53*(1−p1)*p2+T54*(1−p1)*(1−p2)+T163*(1−p2)+T52*p1*(1−p2)+T54*(1−p1)*(1−p2)}*(1−p3)+{T162+T52*p1*(1−p2)+T54*(1−p1)*(1−p2)}*p3 (Expression 3) (Fourth execution path conversion judging device)

Furthermore, in the program shown in FIG. 20, it is assumed as follows.
The execution time from the intermediate code S121 up until the intermediate code S152 is T201.
The execution time from the intermediate code S121 up until the intermediate code S411 is T202.
The execution time from the intermediate code S121 up until the intermediate code S412 is T203.
The execution time from the intermediate code S121 up until the intermediate code S202 is T204.
The probabilities for each of the variables b and e to have the values “5” and “8” at the entrance of the basic block B1 in FIG. 5 are p4 and p5, respectively.

In this case, the average execution time of the program shown in FIG. 20 is expressed as follows.

ET4=T201*p1*p4*p5+(T202+ET1)*((1−p4)+(T203+ET1)*p4*(1−p5)+{T204+T53*(1−p1)*p2+T54*(1−p1)*(1−p2)}*(1−p1)*p4*p5 (Expression 4)

Further, in the program shown in FIG. 22, it is assumed as follows.
The execution time from the intermediate code S121 up until the intermediate code S152 is T221.
The execution time from the intermediate code S121 up until the intermediate code S413 is T222.
The execution time from the intermediate code S121 up until the intermediate code S414 is T223.
The execution time from the intermediate code S121 up until the intermediate code S202 is T224.
The probabilities for each of the variables b and e to have the values “5” and “8” at the entrance of the basic block B1 in FIG. 5 are p4 and p5, respectively.

In this case, the average execution time of the program shown in FIG. 22 is expressed as follows.

ET5=T221*p1*p4*p5+(T222+ET2)*(1−p4)+(T223+ET2)*p4*(1−p5)+{T224+T53*(1−p1)*p2+T54*(1−p1)*(1−p2)}*(1−p1)*p4*p5 (Expression 5) (Sixth execution path conversion judging device)

Furthermore, in the program shown FIG. 32, it is assumed as follows.
The execution time for sequentially executing the basic block B31, the basic block B41, the basic block B51 and the basic block B71 in FIG. 32 is T321.
The execution time for sequentially executing the basic block B31, the basic block B41, the basic block B61 and the basic block B71 is T322.
The execution time for sequentially executing the basic block B61 and the basic block B71 is T323.
The execution time from the intermediate code S12 up until the intermediate code S151 is T324.
The execution time from the intermediate code S12 up until the intermediate code S202 is T325.
The execution time from the intermediate code S12 up until the intermediate code S203 is T326.

In this case, the average execution time of the program shown in FIG. 32 is expressed as follows.

ET6=T324*p1*p2+T325*(1−p1)+T321*p2+T322*(1−p2)+(T326+T322)*p1*(1−p2) (Expression 6)

The optimizing unit 2 controls the conversion processing as follows based on the comparison of the average execution time ET1, the average execution time ET2, the average execution time ET3, the average execution time ET4, the average execution time ET5 and the average execution time ET6 calculated in the manner described above. That is, when the average execution time ET1 is the smallest among all the average execution time, the program of FIG. 5 without conversion is outputted as it is. When other execution time is the smallest, the conversion with the smallest average execution time is outputted as the final intermediate code.

<Supplementary Explanation>

The compiler apparatus according to the present invention has been described as above referring to the embodiment and modification examples. However, it is needless to say that the present invention is not limited to those embodiment and modification examples.

(1) As in the program of FIG. 11, program conversion in <Modification Example 2> is performed on condition that there is no exception to be generated. However, as in the program of FIG. 14, program conversion may be performed considering that there is generation of an exception. Further, as in the program of FIG. 29, program conversion may be performed on condition that the there is branching generated to the middle of the partial intermediate code string.

(2) In <Modification Example 3>, based on the program of FIG. 11, it is converted into the program of FIG. 13 where no exception is generated, and the basic block B174 in the program of FIG. 22 is added further to the program converted in such manner. However, based on the program of the FIG. 14, it is also converted into the program of FIG. 16 where generation of the exception is taken into account, and the basic block B174 in the program of FIG. 22 may be added further to the program converted in such manner.

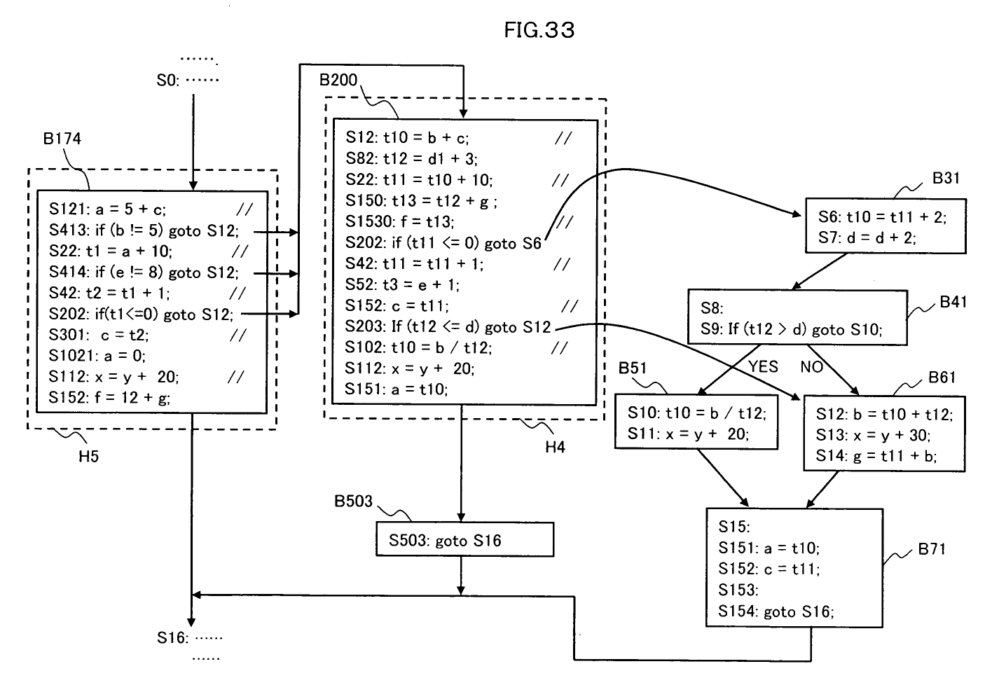

(3) In the embodiment, <Modification Example 2> and <Modification Example 4> are described separately. However, it is also possible to combine <Modification Example 2> and <Modification Example 4>. For example, in the program of FIG. 20 to which <modification Example 2> is carried out, program conversion of <Modification Example 4> may further be performed to the basic blocks B1-B7 in order to be converted into the program of FIG. 33.

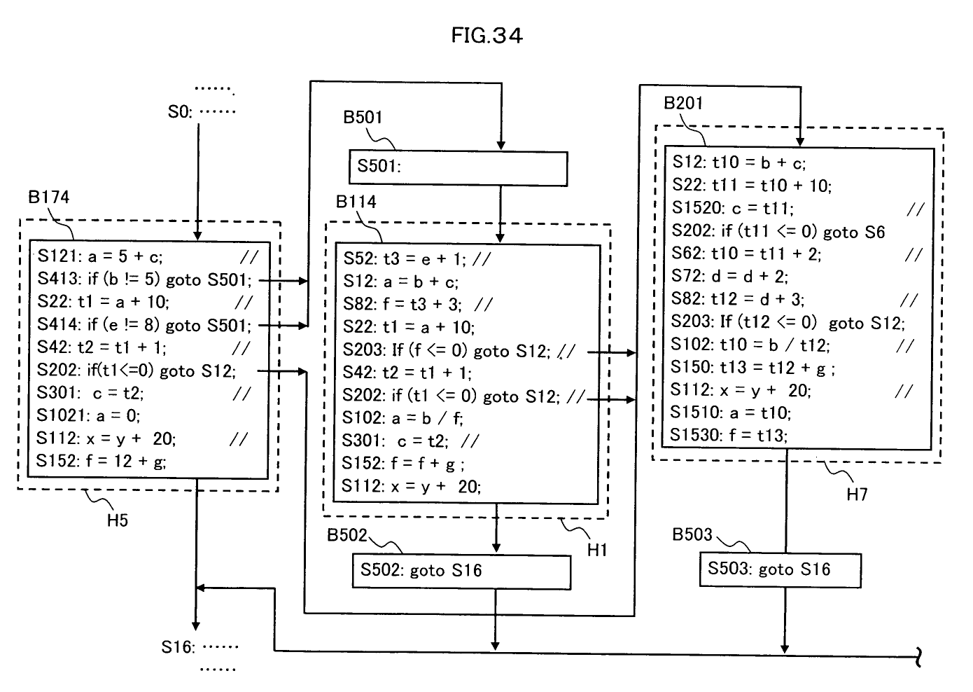

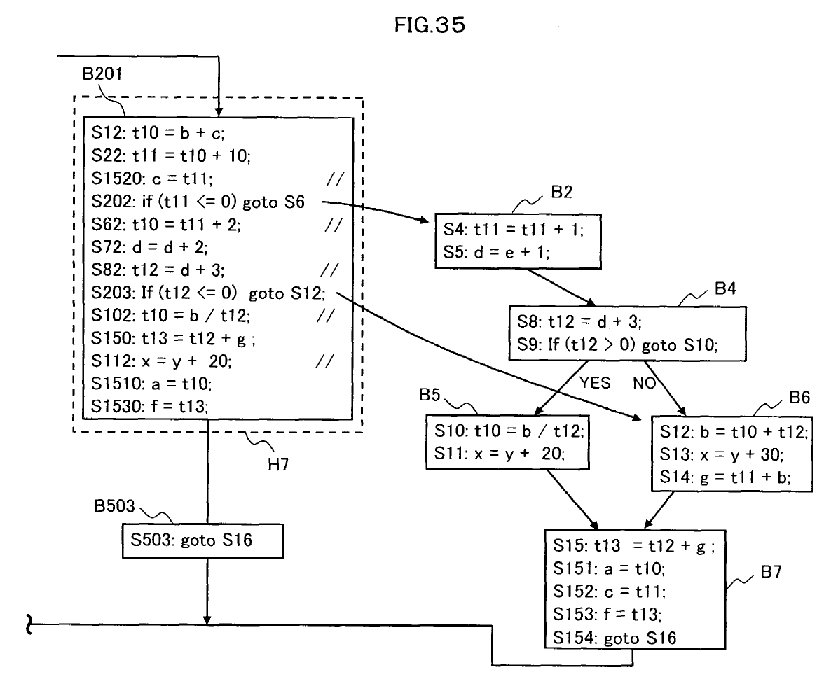

Similarly, it is also possible to combine <Modification Example 3> and <Modification Example 4>. For example, in the program of FIG. 22 to which <modification Example 3> is carried out, program conversion of <Modification Example 4> may be performed to the basic blocks B1-B7 to be converted into the programs of FIG. 34 and FIG. 35 (B201 and B503 in both drawings are the same). In the programs of FIG. 34 and FIG. 35, however, the processing performed to be branched outside from the middle of the high-speed block H7 is the processing that is performed in the program of FIG. 5 so as not to execute the hot path HP. Thus, in the programs of FIG. 34 and FIG. 35, the path through the basic block B1, the basic block B3, the basic block B4, the basic block B5 and the basic block B7 is selected as the hot path that has high execution frequency secondly, and the speed of the selected path is increased.

In addition, other modifications may be employed through combining <Embodiment> and <Modification Example 1>-<Modification Example 4>. New complier apparatuses obtained by combining <Embodiment> and <Modification Example 1>-(Modification Example 4> can be easily constituted by the method described in the embodiment.

(4) In the embodiment, the resource allocation unit 3 is started up following the operation of the intermediate code scheduling section 2B. However, inversely, the resource allocation unit 3 may be started up first, and the intermediate code scheduling section 2B may be started up thereafter.

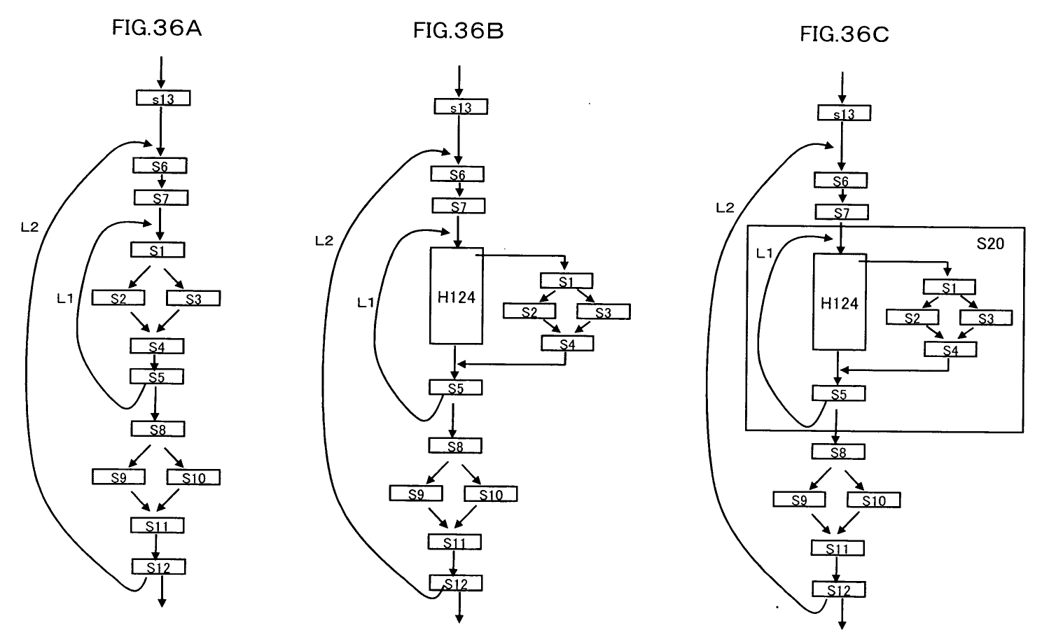

(5) Explanation is not given of the embodiment with respect to the hot path including loop. However, it is possible to apply the program conversion of the embodiment to the innermost loop or to the program after the loop is being expanded, or to apply the program conversion of the embodiment considering that the entire loop is equivalent to a single intermediate code. Further, it is also possible to apply the program conversion according to the embodiment in incremental steps from the innermost loop to the outer loop. For example, in the program of FIG. 36A, when the hot path of the innermost loop L1 is the path going through the intermediate code S1, the intermediate code S2 and the intermediate code S4, the program conversion of the embodiment may be applied. By doing this, a high-speed block H124 can be generated as shown in the program of FIG. 36B. Further, as in the program of FIG. 36C, when the entire loop L1 is treated as a new intermediate code S20 and, for example, the hot path within the loop L2 is the path going through the intermediate code S6, the intermediate code S7, the intermediate code S20, the intermediate code S8, the intermediate code S9 and the intermediate code S11, it is possible to apply the program conversion of the embodiment as in the case of the loop L1.

(6) Furthermore, the present invention may be employed as a recording medium capable of being read out by a computer in which the programs or the digital signals are recorded, e.g. a flexible disk, a hard disk, a CD-ROM, an MO, a DVD, a DVD-ROM, a DVD-RAM, a semiconductor memory and the like. Moreover, the present invention may be applied as the computer programs or the digital signals, which are transmitted via the network or the like such as a telecommunication line, a wire or radio communication line or the Internet.

The present invention has been described in detail referring to the most preferred embodiments. However, various combinations and modifications of the components are possible without departing from the spirit and the broad scope of the appended claims.

What is claimed is:

1. A compiler apparatus for converting a source program that includes a branching instruction into an object program that is a string of object codes, said apparatus comprising
an execution path designating device, a first execution path code generator, a guarantee code generator, a partial code generator, a first branch code generator, a first dependency analyzer and a parallelizing device, wherein:
said execution path designating device designates a single execution path from a plurality of execution paths in a partial instruction string including a branching instruction in a middle thereof, which constitutes said source program;
said first execution code generator generates a first execution path code obtained by replacing a variable, which is defined on an execution path designated by said execution path designating device and is necessary to be present at an entrance of said designated execution path, with another variable;
said guarantee code generator generates a guarantee code for restoring said another variable, which is replaced by said first execution path code generator and is necessary to be present also at an exit of said designated execution path, to an original variable;
said partial code generator generates a partial code that corresponds to said partial instruction string;
said first branch code generator generates a first branch code that branches to a start point of said partial code in said conditional branching instruction on said designated execution path, based on a condition of a conditional branching instruction on said designated execution path, when a branching condition for executing said designated execution path is not approved;
said first dependency analyzer calculates a dependency relation between instructions based on an analysis of a dependency relation performed between instructions on said designated execution path, adds a dependency between said guarantee code and said branch code that corresponds to said conditional branching instruction on said designated execution path so that said guarantee code is executed later than said conditional branching instruction of said designated execution path, and also adds a dependency between instructions so that no exception is generated; and
said parallelizing device rearranges instructions on said designated execution path based on said dependencies between said instructions added by said first dependency analyzer.

2. The compiler apparatus according to claim 1, which treats a loop included in said source program as a single instruction, said apparatus further comprising a loop unit processing device, wherein
said loop unit processing device starts up said execution path designating device, said first execution path code generator, said guarantee code generator, said first branch code generator, said first dependency analyzer and said parallelizing device from an innermost loop of said loop towards an outer loop.

3. The compiler apparatus according to claim 1, further comprising a first execution path conversion judging device, wherein said first execution path conversion judging device judges whether or not said program after executing said parallelizing device is taken as said object codes, based on an execution probability of said designated execution path.

4. The compiler apparatus according to claim 1, further comprising a second execution path conversion judging device, wherein said second execution path conversion judging device:
calculates average execution time of said partial code, based on an execution probability of said designated execution path and execution time of said partial code;
calculates average execution time of said designated execution path, based on execution time of said object codes in said designated execution path and said execution probability after executing said parallelizing device; and
judges whether or not said program after executing said parallelizing device is taken as said string of object codes, based on a comparison between said average execution time of said partial code and said average execution time of said designated execution path.

5. The compiler apparatus according to claim 1, further comprising a return point setting instruction code generator and a second dependency analyzer, wherein:
said return point setting instruction code generator adds an instruction code for specifying a return point on said designated execution path when an exception is generated during execution of said designated execution path; and
said second dependency analyzer adds a dependency between said guarantee code and said branch code that corresponds to said conditional branching instruction on said designated execution path so that said guarantee code is executed later than said conditional branching instruction on said designated execution path, based on an analysis of a dependency relation between instructions on said designated execution path; and
said second dependency analyzer does not add said dependency, that is added between said instructions by said first dependency analyzer lest an exception is generated.

6. The compiler apparatus according to claim 5, further comprising an processing routine adder at generation of interruption, wherein said processing routine adder at generation of interruption adds a processing routine for returning to said return point designated by said instruction code to said object codes, when an exception is generated.

7. The compiler apparatus according to claim 6, further comprising a third execution path conversion judging device, wherein said third execution path conversion judging device judges whether or not said program after executing said parallelizing device is taken as said object codes, based on an execution probability of said designated execution path and a probability of generating an exception on said execution path after executing said parallelizing device.

8. The compiler apparatus according to claim 7, further comprising a fourth execution path conversion judging device, wherein said fourth execution path conversion judging device:
calculates average execution time of said partial code, based on said execution probability of said designated execution path, said probability of generating an exception on said designated execution path and execution time of said partial code;
calculates average execution time of said designated execution path after executing said parallelizing device and average execution time of said processing routine, based on said execution probability of said designated execution path, said probability of generating said exception, execution time of said object codes on said execution path after executing said parallelizing device and execution time of said object codes in said processing routine added by said processing routine adder at generation of interruption; and
judges whether or not said program after executing said parallelizing device is taken as said object codes, based on a comparison between said average execution time of said execution path after executing said parallelizing device and said average execution time of said processing routine.

9. The compiler apparatus according to claim 8, further comprising a second execution path code generator, wherein:
said second execution path code generator replaces said variable with a value held by said variable when a variable referred to on said designated execution path often holds a specific value, and generates a second execution path code obtained by inserting a conditional branching instruction, where a condition is set to branch towards outside of said designated execution path, at a head of said designated execution path, when said variable holds a value different from said replaced value; and
said compiler apparatus performs redundancy eliminating optimization concerning a constant value, after said second execution path code generator is started up.

10. The compiler apparatus according to claim 9, further comprising a fifth execution path conversion judging device, wherein said fifth execution path conversion judging device judges whether or not said second execution path code generator is executed, based on said execution probability of said designated execution path and said probability wherein said variable on said designated execution path holds a specific value.

11. The compiler apparatus according to claim 10, further comprising a sixth execution path conversion judging device, wherein said sixth execution path conversion judging device:
calculates average execution time of said execution path after executing said parallelizing device, based on said execution probability of said designated execution path, said probability wherein said variable on said designated execution path holds a specific value and execution time of said object codes on said execution path after executing said parallelizing device; and
judges whether or not said program after executing said parallelizing device is taken as said object codes based on a comparison between said average execution time of said execution path after executing said parallelizing device and said average execution time of said partial code.

12. The compiler apparatus according to claim 11, further comprising a third execution path code generator and a second branch code generator, wherein:
said third execution path code generator copies instructions on said designated execution path and then replaces said variable that often takes a specific value on said copied execution path with a value held by said variable, when a variable referred to on said designated execution path often holds a specific value, and generates a third execution path code that is obtained by inserting a conditional branching instruction, where a condition is set to branch towards outside of said designated execution path, at a head of said designated execution path, when a variable referred to on said designated execution path holds a value different from said replaced value; and
said second branch code generator generates a second branch code that branches to a start point of said designated execution path code in said conditional branching instruction on said copied execution path, when a condition of a conditional branching instruction on said copied execution path is not approved to a conditional branching instruction in said designated execution path.

13. The compiler apparatus according to claim 12, further comprising a seventh execution path conversion judging device, wherein said seventh execution path conversion judging device:
calculates average execution time of said program after being modified, based on said probability wherein said variable on said designated execution path holds a specific value, or based on said execution time of said designated execution path and said probability wherein said variable on said designated execution path holds a specific value; and
judges whether or not said third execution path code generator and said second branch code generator are executed, based on said calculated average execution time of said modified program.

14. A compiler apparatus for converting a source program including a branching instruction into an object program that is a string of object codes, said apparatus comprising
an execution path designating device, an execution path code generator, a guarantee code generator, a partial code generator, a branch code generator, a dependency analyzer and a parallelizing device, wherein:
said execution path designating device designates a single execution path from a plurality of execution paths contained in a partial instruction string including a branching instruction in a middle thereof, that constitutes said source program;
said execution code generator generates an execution path code obtained by replacing a variable, that is defined on an execution path designated by said execution path designating device and is necessary to be present at an entrance of said designated execution path, with another variable;
said guarantee code generator generates a guarantee code for restoring said another variable, that is replaced by said execution path code generator and is necessary to be present also at an exit of said designated execution path, to an original variable;
said partial code generator generates a partial code that corresponds to said partial instruction string;
said branch code generator generates a branch code so that a branching destination of said conditional branching instruction on said designated execution path is designated to a branching destination of a case where said branching condition in said partial code is not approved, when said branching condition for executing said designated execution path is not approved, based on a condition of a conditional branching instruction on said designated execution path;
said dependency analyzer calculates a dependent relation between instructions based on an analysis of a dependent relation performed between instructions on said designated execution path, and simultaneously adds a dependency between an instruction present in a basic block and said conditional branching instruction so that processing cannot be shifted by going over said conditional branching instruction that is found towards an end direction of said execution path from an instruction in said designated execution path that is present in said basic block where controls interflow, and adds a dependency between said instruction and said conditional branching instruction so that processing cannot be moved by going over said conditional branching instruction from said instruction in said designated execution path that is not present in said basic block; and
said parallelizing device rearranges instructions in said designated execution path based on said dependencies between said instructions added by said dependency analyzer.

15. The compiler apparatus according to claim 14, further comprising a confluence definition variable replacing device and a confluence definition variable guarantee code generator, wherein:
said confluence definition variable replacing device replaces a defined point and a reference point of said variable with another variable, when there exists a variable defined in a basic block where controls interflow, in a partial instruction string containing a branch instruction in a middle thereof which constitutes said source program; and
said confluence definition variable guarantee code generator generates a guarantee code, at an exit of said partial instruction string, for restoring said another variable, which is replaced by said confluence definition variable replacing device and is necessary to be present at said exit of said partial instruction string, to an original variable.

16. The compiler apparatus according to claim 15, further comprising a first execution path conversion judging device, wherein said first execution path conversion judging device judges whether or not said program after executing said parallelizing device is taken as said object codes, based on said execution probability of said designated execution path.

17. The compiler apparatus according to claim 16, further comprising a second execution path conversion judging device, wherein said second execution path conversion judging device:
calculates average execution time of said partial code, based on an execution probability of said designated execution path and execution time of said partial code;
calculates average execution time of said execution path after executing said parallelizing device, based on said execution probability of said designated execution path and execution time of said object codes in said execution path after executing said parallelizing device; and
judges whether or not said program after executing said parallelizing device is taken as said string of object codes, based on a comparison between said average execution time of said partial code and said average execution time of said execution path after executing said parallelizing device.

18. A compiler apparatus for converting a source program including a branching instruction into an object program that is a string of object codes, said apparatus comprising
an execution path designating device, a first execution path code generator, a first guarantee code generator, a second execution path code generator, a confluence definition variable replacing device, a confluence definition variable guarantee code generator, a third execution path code generator, a second guarantee code generator, a partial code generator, a first branch code generator, a second branch code generator, a third branch code generator, a dependency analyzer and a parallelizing device, wherein:
said execution path designating device designates a single execution path from a plurality of execution paths in a partial instruction string including a branching instruction in a middle thereof, that constitutes said source program;
said first execution code generator generates a first execution path code that is an object code corresponding to an entire instruction string on an execution path designated by said execution path designating device, and obtained by replacing a variable, which is necessary to be present at an entrance of said designated execution path and is defined on an execution path designated by said execution path designating device, with first another variable;
said first guarantee code generator generates a first guarantee code for restoring said first another variable, which is necessary to be present at an exit of said designated execution path, to an original variable;
said second execution path code generator copies said code string and replaces said variable that often holds said specific value in said copied code string with a value held by said variable, when a variable referred in a code string that is generated by said first execution path code generator and by said first guarantee code generator often holds a specific value, and generates a second execution path code obtained by inserting a conditional branching instruction, at a head of said code string, where a condition is set to branch towards outside of said designated execution path, when said variable referred to in said code string holds a value different from said replaced value;
said confluence definition variable replacing device replaces a defined point and a reference point of a variable with second another variable, when there exists such variable defined in a basic block where controls interflow in said partial instruction string;
said confluence definition variable guarantee code generator generates a variable guarantee code, at an exit of said partial instruction string, for restoring said second another variable, which is necessary to be present at said exit of said partial instruction string, to an original variable;
said third execution path code generator generates a third execution path code that is an object code corresponding to an entire instruction string on said execution path designated by said execution path designating device after executing said confluence definition variable replacing device and said confluence definition variable guarantee code generator, and obtained by replacing a variable, which is necessary to be present at an entrance of said designated execution path and is defined on said designated execution path, with third another variable;
said second guarantee code generator generates a second guarantee code for restoring said third another variable, which is necessary to be present at an exit of said designated execution path, to an original variable;
said partial code generator generates a partial code that corresponds to said partial instruction string after executing said confluence definition variable replacing device and said confluence definition variable guarantee code generator;
said first branch code generator generates a first branch code so that a branching destination of said conditional branching instruction in said third execution path is designated to a branching destination of a case where said branching condition in said partial code is not approved, when said branching condition for executing said designated execution path is not approved, based on a condition of a conditional branching instruction in said third execution path code;
said second branch code generator generates a second branch code that branches to a start point of said third execution path code in said branching instruction within said first execution path code, when a branching condition for executing said designated execution path is not approved, based on a condition of a conditional branching instruction in said first execution path code;
said third branch code generator generates a third branch code that branches to a start point of said first execution path code in said branching instruction within said second execution path code, when a branching condition for executing said designated execution path is not approved, based on a condition of a conditional branching instruction in said second execution path code;
said dependency analyzer calculates a dependency relation between instructions based on an analysis of a dependency relation between said instructions in each of code strings which are generated by said first execution path code generator, said first guarantee code generator, said second execution path code generator, said third execution path code generator and said second guarantee code generator; and
said parallelizing device rearranges said instructions on said designated execution path based on said dependency relation between said instructions calculated by said dependency analyzer.

19. A compiler method for converting a source program including a branching instruction into an object program that is a string of object codes, said method comprising steps of:
an execution path designating step for designating a single execution path from a plurality of execution paths in a partial instruction string including a branching instruction in a middle thereof, that constitutes said source program;
a first execution code generating step for generating a first execution path code obtained by replacing a variable, which is defined on an execution path designated by said execution path designating step and is necessary to be present at an entrance of said designated execution path, with another variable;
a guarantee code generating step for generating a guarantee code for restoring said another variable, which is replaced by said first execution path code generating step and is necessary to be present also at an exit of said designated execution path, to an original variable;
a partial code generating step for generating a partial code that corresponds to said partial instruction string;
a first branch code generating step for generating a first branch code that branches to a start point of said partial code in said conditional branching instruction on said designated execution path, when a branching condition for executing said designated execution path is not approved, based on a condition of a conditional branching instruction on said designated execution path;
a first dependency analyzing step calculates a dependency relation between instructions based on an analysis of a dependent relation between instructions on said designated execution path, and also adds a dependency between said guarantee code and said branch code that corresponds to said conditional branching instruction on said designated execution path so that said guarantee code is executed later than said conditional branching instruction of said designated execution path, and adds a dependency between said instructions lest exception is generated; and
a parallelizing step for rearranging said instructions on said designated execution path based on said dependencies between said instructions added by said first dependency analyzing step.

20. The compiler method according to claim 19, further comprising steps of:
a return point setting instruction code generating step for adding an instruction code for specifying a return point on said designated execution path when an exception is generated during execution on said designated execution path; and
a second dependency analyzing step for adding a dependency between said guarantee code and said branch code that corresponds to said conditional branching instruction on said designated execution path so that said guarantee code is executed later than said conditional branching instruction on said designated execution path, based on an analysis of a dependent relation between said instructions on said designated execution path, wherein
said second dependency analyzing step does not add said dependency, which is added between said instructions by said first dependency analyzing step lest an exception is generated.

21. The compiler method according to claim 20, further comprising a processing routine adding step at generation of interruption, which adds a processing routine for returning to said return point designated by said instruction code, to said object codes, when an exception is generated.

22. A compiler method for converting a source program including a branching instruction into an object program that is a string of object codes, said method comprising steps of:
an execution path designating step for designating a single execution path from a plurality of execution paths in a partial instruction string including a branching instruction in a middle thereof, which constitutes said source program;
a first execution code generating step for generating a first execution path code that is an object code corresponding to an entire instruction string on an execution path designated by said execution path designating step, and obtained by replacing a variable, which is necessary to be present at an entrance of said designated execution path and is defined on said execution path designated by said execution path designating device, with first another variable;
a first guarantee code generating step for generating a first guarantee code for restoring said first another variable, which is necessary to be present at an exit of said designated execution path, to an original variable;
a second execution path code generating step copies said code string and replaces said variable that often holds said specific value in said copied code string with a value held by said variable, when a variable referred to in a code string that is generated by said first execution path code generating step and said first guarantee code generating step often holds a specific value, and generates a second execution path code that is obtained by inserting a conditional branching instruction, at a head of said code string, where a condition is set to branch towards outside of said designated execution path, when said variable referred to in said code string holds a value different from said replaced value;
a confluence definition variable replacing step for replacing a defined point and a reference point of a variable with second another variable, when there exists such variable defined in a basic block where controls interflow in said partial instruction string;
a confluence definition variable guarantee code generating step for generating a variable guarantee code for restoring said second another variable, which is said second another variable and is necessary to be present at said exit of said partial instruction string, to an original variable.
a third execution path code generating step for generating a third execution path code that is an object code corresponding to an entire instruction string on said designated execution path after execution of said confluence definition variable replacing step and said confluence definition variable guarantee code generating step, and obtained by replacing a variable, which is necessary to be present at an entrance of said designated execution path and is defined on said designated execution path, with third another variable;
a second guarantee code generating step for generating a second guarantee code for restoring said third another variable, which is necessary to be present at an exit of said designated execution path, to an original variable;
a partial code generating step for generating a partial code that corresponds to said partial instruction string after execution of said confluence definition variable replacing step and said confluence definition variable guarantee code generating step;
a first branch code generating step for generating a first branch code so that a branching destination of said conditional branching instruction in said third execution path code is designated to a branching destination of a case where said branching condition in said partial code is not approved, when said branching condition for executing said designated execution path is not approved, based on a condition of a conditional branching instruction in said third execution path code;
a second branch code generating step for generating a second branch code that branches to a start point of said third execution path code in said branching instruction in said first execution path code, when a branching condition for executing said designated execution path is not approved, based on a condition of a conditional branching instruction in said first execution path code;
a third branch code generating step for generating a third branch code that branches to a start point of said first execution path code in said branching instruction in said second execution path code, when a branching condition for executing said designated execution path is not approved, based on a condition of a conditional branching instruction in said second execution path code;
a dependency analyzing step for calculating a dependency relation between instructions based on an analysis of a dependency relation between said instructions in each of code strings which are generated by said first execution path code generating step, said first guarantee code generating step, said second execution path code generating step, said third execution path code generating step and said second guarantee code generating step; and
a parallelizing step for rearranging said instructions on said designated execution path based on said dependency relation between said instructions calculated by said dependency analyzing step.

23. A compiler program for converting a source program including a branching instruction into an object program that is a string of object codes, which makes a computer execute steps of:
an execution path designating step for designating a single execution path from a plurality of execution paths in a partial instruction string including a branching instruction in a middle thereof, which constitutes said source program;
a first execution code generating step for generating a first execution path code obtained by replacing a variable, which is defined on an execution path designated by said execution path designating step and is necessary to be present at an entrance of said designated execution path, with another variable;
a guarantee code generating step for generating a guarantee code for restoring said another variable, which is replaced by said first execution path code generating step and is necessary to be present also at an exit of said designated execution path, to an original variable;
a partial code generating step for generating a partial code that corresponds to said partial instruction string;
a first branch code generating step for generating a first branch code that branches to a start point of said partial code in said conditional branching instruction on said designated execution path, when a branching condition for executing said designated execution path is not approved, based on a condition of a conditional branching instruction on said designated execution path;
a first dependency analyzing step calculates a dependency relation between instructions based on an analysis of a dependency relation performed between said instructions on said designated execution path, and also adds a dependency between said guarantee code and said branch code that corresponds to said conditional branching instruction on said designated execution path so that said guarantee code is executed later than said conditional branching instruction on said designated execution path, and adds a dependency between instructions lest exception is generated; and
a parallelizing step for rearranging said instructions on said designated execution path based on said dependencies between said instructions added by said first dependency analyzing step.

24. The compiler program according to claim 23, further comprising, as steps for said computer to execute:
a return point setting instruction code generating step for adding an instruction code for specifying a return point on said designated execution path when an exception is generated during execution of said designated execution path; and
a second dependency analyzing step for adding a dependency between said guarantee code and said branch code that corresponds to said conditional branching instruction on said designated execution path so that said guarantee code is executed later than said conditional branching instruction on said designated execution path, based on an analysis of a dependency relation between said instructions on said designated execution path, wherein
said second dependency analyzing step does not add a dependency, which is added between said instructions by said first dependency analyzing step lest an exception is generated.

25. The compiler method according to claim 24, further comprising, as a step for making said computer execute, a processing routine adding step at generation of interruption for adding a processing routine for returning to said return point designated by said instruction code, to said object codes, when an exception is generated.

26. A compiler program for converting a source program including a branching instruction into an object program that is a string of object codes, which makes a computer execute steps of:
an execution path designating step for designating a single execution path from a plurality of execution paths in a partial instruction string including a branching instruction in a middle thereof, which constitutes said source program;
a first execution code generating step for generating a first execution path code that is an object code corresponding to an entire instruction string on an execution path designated by said execution path designating step, and obtained by replacing a variable, which is necessary to be present at an entrance of said designated execution path and is defined on an execution path designated by said execution path designating device, with first another variable;
a first guarantee code generating step for generating a first guarantee code for restoring said first another variable, which is necessary to be present at an exit of said designated execution path, to an original variable;
a second execution path code generating step for copying said code string and then replacing said variable that often holds said specific value in said copied code string with a value held by said variable, when a variable referred to in a code string that is generated by said first execution path code generating step and said first guarantee code generating step often holds a specific value, and generating a second execution path code that is obtained by inserting a conditional branching instruction, at a head of said code string, where a condition is set to branch towards outside of said designated execution path, when said variable referred to in said code string holds a value different from said replaced value;
a confluence definition variable replacing step for replacing a defined point and a reference point of a variable with second another variable, when there exists such variable defined in a basic block where controls interflow in said partial instruction string;
a confluence definition variable guarantee code generating step for generating a variable guarantee code for restoring said second another variable to an original variable, at an exit of said partial instruction string, with respect to said second another variable which is necessary to be present at said exit of said partial instruction string;
a third execution path code generating step for generating a third execution path code that is an object code corresponding to an entire instruction string on said designated execution path after executing said confluence definition variable replacing step and said confluence definition variable guarantee code generating step, and obtained by replacing a variable, which is necessary to be present at an entrance of said designated execution path and is defined on said designated execution path, with third another variable;
a second guarantee code generating step for generating a second guarantee code for restoring said third another variable, which is necessary to be present at an exit of said designated execution path, to an original variable;
a partial code generating step for generating a partial code that corresponds to said partial instruction string after execution of said confluence definition variable replacing step and said confluence definition variable guarantee code generating step;
a first branch code generating step which generates a first branch code so that a branching destination of said conditional branching instruction on said third execution path is designated to a branching destination of a case where said branching condition in said partial code is not approved, when said branching condition for executing said designated execution path is not approved, based on a condition of a conditional branching instruction in said third execution path code;
a second branch code generating step for generating a second branch code that branches to a start point of said third execution path code in said branching instruction in said first execution path code, when a branching condition for executing said designated execution path is not approved, based on a condition of a conditional branching instruction in said first execution path code;
a third branch code generating step for generating a third branch code that branches to a start point of said first execution path code in said branching instruction in said second execution path code, when a branching condition for executing said designated execution path is not approved, based on a condition of a conditional branching instruction in said second execution path code;
a dependency analyzing step for calculating a dependency relation between instructions based on an analysis of a dependency relation between said instructions in each of code strings which are generated by said first execution path code generating step, said first guarantee code generating step, said second execution path code generating step, said third execution path code generating step and said second guarantee code generating step; and
a parallelizing step for rearranging said instructions on said designated execution path based on said dependency relation between said instructions calculated by said dependency analyzing step.
